(19) United States
(12) Patent Application Publication
(10) Pub. No.: US 2025/0062794 A1
(43) Pub. Date: Feb. 20, 2025

(54) RECONFIGURABLE INTELLIGENT SURFACE CO-EXISTENCE

(71) Applicant: QUALCOMM INCORPORATED, San Diego, CA (US)

(72) Inventors: Saeid Sahraei, San Diego, CA (US); Yu Zhang, San Diego, CA (US); Peter Gaal, San Diego, CA (US); Krishna Kiran Mukkavilli, San Diego, CA (US); Wanshi Chen, San Diego, CA (US); Hwan Joon Kwon, San Diego, CA (US); Tingfang Ji, San Diego, CA (US); Hung Dinh Ly, San Diego, CA (US)

(21) Appl. No.: 18/721,580

(22) PCT Filed: Feb. 28, 2022
(86) PCT No.: PCT/CN2022/078200

§ 371 Date: Jun. 18, 2024

(51) Int. Cl. H04B 7/04; H04L 25/02

(52) U.S. Cl. CPC H04B 7/04013; H04L 25/0202

(57) ABSTRACT

Methods, systems, and devices for wireless communication are described. A first wireless communications device may receive, from a second wireless communications device, a signal that is indicative of a phase-change pattern applied to communications between the first wireless communications device and the second wireless communication device by a reconfigurable intelligent surface reflecting the communications. The first device may determine the phase-change pattern from the signal. The first device may transmit a message to the second wireless communications device, wherein at least one of a content or a transmission property of the message is based at least in part on the phase-change pattern.

### CROSS REFERENCE

The present application is a 371 national stage filing of International PCT Application No. PCT/CN2022/078200 by SAHRAEI et al. entitled “RECONFIGURABLE INTELLIGENT SURFACE CO-EXISTENCE,” filed Feb. 28, 2022, which is assigned to the assignee hereof, and which is expressly incorporated by reference in its entirety herein.

### FIELD OF TECHNOLOGY

The following relates to wireless communication, including reconfigurable intelligent surface co-existence.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities (e.g., base stations), each supporting wireless communication for communication devices, which may be known as user equipment (UE).

### SUMMARY

The described techniques relate to improved methods, systems, devices, and apparatuses that support reconfigurable intelligent surface co-existence. For example, the described techniques provide for Generally, the described techniques provide various mechanisms supporting detection by a user equipment (UE) and/or network entity that a reconfigurable intelligent surface (RIS) is using a watermarking or phase-change pattern (e.g., a RIS that is configured by some other network entity that is associated with the same or a different network operator). In one proposal, a network entity learns of the watermarking pattern applied by the RIS through communications with another device (the other network entity managing the RIS and/or a UE communicating via the RIS) that is already aware of the watermarking pattern. The network entity then sends an explicit indication of the pattern to its UEs so that the UEs may adjust (via time or phase) transmissions accordingly. In a second proposal, the network entity may transmit one or more reference signals (e.g., a new reference signal and/or a modified phase tracking reference signal (PT-RS)) to a UE. The reference signal is received at the UE via the RIS. The UE will measure the reference signal and, if a phase change pattern is detected, the UE may determine that the RIS is present and applying watermarking (e.g., phase, time, and/or frequency shifting of the signal), and the UE may be able to determine the pattern. The UE may report the phase-change pattern to the network entity. Accordingly, the UE and network entity may compensate for the RIS being deployed within the network for wireless communications by selecting, adjusting, or otherwise determining transmission parameters for the subsequent communications that mitigate the effects of the RIS watermarking.

A method for wireless communication at a first wireless communications device is described. The method may include receiving, from a second wireless communications device, a signal that is indicative of a phase-change pattern applied to communications between the first wireless communications device and the second wireless communications device by a RIS reflecting the communications, determining the phase-change pattern from the signal, and transmitting a message to the second wireless communications device, where at least one of a content or a transmission property of the message is based on the phase-change pattern.

An apparatus for wireless communication at a first wireless communications device is described. The apparatus may include a processor, memory coupled with the processor, and instructions stored in the memory. The instructions may be executable by the processor to cause the apparatus to receive, from a second wireless communications device, a signal that is indicative of a phase-change pattern applied to communications between the first wireless communications device and the second wireless communications device by a RIS reflecting the communications, determine the phase-change pattern from the signal, and transmit a message to the second wireless communications device, where at least one of a content or a transmission property of the message is based on the phase-change pattern.

Another apparatus for wireless communication at a first wireless communications device is described. The apparatus may include means for receiving, from a second wireless communications device, a signal that is indicative of a phase-change pattern applied to communications between the first wireless communications device and the second wireless communications device by a RIS reflecting the communications, means for determining the phase-change pattern from the signal, and means for transmitting a message to the second wireless communications device, where at least one of a content or a transmission property of the message is based on the phase-change pattern.

A non-transitory computer-readable medium storing code for wireless communication at a first wireless communications device is described. The code may include instructions executable by a processor to receive, from a second wireless communications device, a signal that is indicative of a phase-change pattern applied to communications between the first wireless communications device and the second wireless communications device by a RIS reflecting the communications, determine the phase-change pattern from the signal, and transmit a message to the second wireless communications device, where at least one of a content or a transmission property of the message is based on the phase-change pattern.

In some examples of the method, apparatuses, and non-transitory computer-readable medium described herein, determining the phase-change pattern may include operations, features, means, or instructions for receiving an indication of the phase-change pattern in the signal, where determining the phase-change pattern may be based on the indication.

In some examples of the method, apparatuses, and non-transitory computer-readable medium described herein, the indication of the phase-change pattern includes a symbol or slot pattern for the phase-change pattern, a watermarking pattern for the RIS, or both.

In some examples of the method, apparatuses, and non-transitory computer-readable medium described herein, determining the phase-change pattern may include operations, features, means, or instructions for performing a set of channel estimation measurements using the signal over a time period, comparing the set of channel estimation measurements to each of a set of multiple available sets of phase-change patterns, and identifying the phase-change pattern from the available sets of phase-change patterns based on the comparing.

Some examples of the method, apparatuses, and non-transitory computer-readable medium described herein may further include operations, features, means, or instructions for receiving, from the second wireless communications device, a configuration signal identifying the available sets of phase-change patterns, where the configuration signal includes a downlink control information, a medium access control-control element, a radio resource control, or any combination thereof.

In some examples of the method, apparatuses, and non-transitory computer-readable medium described herein, each phase-change pattern in the available sets of phase-change patterns may be associated with a symbol or slot pattern for the phase-change pattern, a watermarking pattern for the RIS, or a combination thereof.

In some examples of the method, apparatuses, and non-transitory computer-readable medium described herein, the signal includes a reference signal used for RIS detection and tracking, a phase-tracking reference signal, or both.

In some examples of the method, apparatuses, and non-transitory computer-readable medium described herein, the signal including the phase-tracking reference signal may be received in an uplink control channel, a downlink control channel, or both.

In some examples of the method, apparatuses, and non-transitory computer-readable medium described herein, the signal including the phase-tracking reference signal may be received in a first subband that may be different from a second subband configured for data communications between the first wireless communications device and the second wireless communications device.

In some examples of the method, apparatuses, and non-transitory computer-readable medium described herein, the signal may be received via one tone per-physical resource block or per-resource block group configured for the first wireless communications device.

In some examples of the method, apparatuses, and non-transitory computer-readable medium described herein, performing the set of channel estimation measurements using the signal over the time period may include operations, features, means, or instructions for identifying a periodicity for the phase-change pattern and performing a set of channel estimation measurements using a set of multiple signals, each received during different periodic instances of the phase-change pattern in accordance with the periodicity.

Some examples of the method, apparatuses, and non-transitory computer-readable medium described herein may further include operations, features, means, or instructions for adjusting, based on the phase-change pattern, the transmission property during subsequent communications between the first wireless communications device and the second wireless communications device, where the transmission property includes a phase, a timing, a frequency, or any combination thereof.

Some examples of the method, apparatuses, and non-transitory computer-readable medium described herein may further include operations, features, means, or instructions for configuring the content of the message to indicate the phase-change pattern.

A method for wireless communication at a first wireless communications device is described. The method may include determining a phase-change pattern applied to communications between the first wireless communications device and a second wireless communications device by a RIS reflecting the communications and transmitting a message to the second wireless communications device indicative of the phase-change pattern, where at least one of a content or a transmission property is based on the phase-change pattern.

An apparatus for wireless communication at a first wireless communications device is described. The apparatus may include a processor, memory coupled with the processor, and instructions stored in the memory. The instructions may be executable by the processor to cause the apparatus to determine a phase-change pattern applied to communications between the first wireless communications device and a second wireless communications device by a RIS reflecting the communications and transmit a message to the second wireless communications device indicative of the phase-change pattern, where at least one of a content or a transmission property is based on the phase-change pattern.

Another apparatus for wireless communication at a first wireless communications device is described. The apparatus may include means for determining a phase-change pattern applied to communications between the first wireless communications device and a second wireless communications device by a RIS reflecting the communications and means for transmitting a message to the second wireless communications device indicative of the phase-change pattern, where at least one of a content or a transmission property is based on the phase-change pattern.

A non-transitory computer-readable medium storing code for wireless communication at a first wireless communications device is described. The code may include instructions executable by a processor to determine a phase-change pattern applied to communications between the first wireless communications device and a second wireless communications device by a RIS reflecting the communications and transmit a message to the second wireless communications device indicative of the phase-change pattern, where at least one of a content or a transmission property is based on the phase-change pattern.

In some examples of the method, apparatuses, and non-transitory computer-readable medium described herein, determining the phase-change pattern may include operations, features, means, or instructions for receiving, from a third wireless communications device, an indication of the phase-change pattern, where the message transmitted to the second wireless communications device includes the indication of the phase-change pattern.

In some examples of the method, apparatuses, and non-transitory computer-readable medium described herein, the indication of the phase-change pattern includes a symbol or slot pattern for the phase-change pattern, a watermarking pattern for the RIS, or both.

In some examples of the method, apparatuses, and non-transitory computer-readable medium described herein, the third wireless communications device includes a network entity associated with the RIS, a user equipment (UE) associated with the first wireless communications device, or both.

In some examples of the method, apparatuses, and non-transitory computer-readable medium described herein, determining the phase-change pattern may include operations, features, means, or instructions for transmitting, to the second wireless communications device, a signal to which the phase-change pattern may be applied by the RIS and receiving an indication of the phase-change pattern from the second wireless communications device, where the indication may be based on measurements of the signal.

Some examples of the method, apparatuses, and non-transitory computer-readable medium described herein may further include operations, features, means, or instructions for transmitting, to the second wireless communications device, a configuration signal identifying available sets of phase-change patterns, where the configuration signal includes a downlink control information, a medium access control-control element, a radio resource control, or any combination thereof.

In some examples of the method, apparatuses, and non-transitory computer-readable medium described herein, each phase-change pattern in the available sets of phase-change patterns may be associated with a symbol or slot pattern for the phase-change pattern, a watermarking pattern for the RIS, or a combination thereof.

In some examples of the method, apparatuses, and non-transitory computer-readable medium described herein, the signal includes a reference signal used for RIS detection and tracking, a phase-tracking reference signal, or both.

In some examples of the method, apparatuses, and non-transitory computer-readable medium described herein, the signal including the phase-tracking reference signal may be transmitted in an uplink control channel, an uplink data channel, a downlink control channel, a downlink data channel, or any combination thereof.

In some examples of the method, apparatuses, and non-transitory computer-readable medium described herein, the signal including the phase-tracking reference signal may be transmitted in a first subband that may be different from a second subband configured for data communications between the first wireless communications device and the second wireless communications device.

In some examples of the method, apparatuses, and non-transitory computer-readable medium described herein, the signal may be received via one tone per-physical resource block or per-resource block group configured for the first wireless communications device.

Some examples of the method, apparatuses, and non-transitory computer-readable medium described herein may further include operations, features, means, or instructions for adjusting, based on the phase-change pattern, the transmission property during subsequent communications between the first wireless communications device and the second wireless communications device, where the transmission property includes a phase, a timing, a frequency, or any combination thereof.

Some examples of the method, apparatuses, and non-transitory computer-readable medium described herein may further include operations, features, means, or instructions for configuring the content of the message to indicate the phase-change pattern.

### BRIEF DESCRIPTION OF THE DRAWINGS

FIG. 1 illustrates an example of a wireless communications system that supports reconfigurable intelligent surface co-existence in accordance with one or more aspects of the present disclosure.

FIG. 2 illustrates an example of a wireless communication system that supports reconfigurable intelligent surface co-existence in accordance with one or more aspects of the present disclosure.

FIG. 3 illustrates an example of a wireless communication system that supports reconfigurable intelligent surface co-existence in accordance with one or more aspects of the present disclosure.

FIG. 4 illustrates an example of a RS configuration that supports reconfigurable intelligent surface co-existence in accordance with one or more aspects of the present disclosure.

FIG. 5 illustrates an example of a RS configuration that supports reconfigurable intelligent surface co-existence in accordance with one or more aspects of the present disclosure.

FIG. 6 illustrates an example of a process that supports reconfigurable intelligent surface co-existence in accordance with one or more aspects of the present disclosure.

FIGS. 7 and 8 show block diagrams of devices that support reconfigurable intelligent surface co-existence in accordance with one or more aspects of the present disclosure.

FIG. 9 shows a block diagram of a communications manager that supports reconfigurable intelligent surface co-existence in accordance with one or more aspects of the present disclosure.

FIG. 10 shows a diagram of a system including a user equipment (UE) that supports reconfigurable intelligent surface co-existence in accordance with one or more aspects of the present disclosure.

FIG. 11 shows a diagram of a system including a network entity (e.g., a base station) that supports reconfigurable intelligent surface co-existence in accordance with one or more aspects of the present disclosure.

FIGS. 12 through 16 show flowcharts illustrating methods that support reconfigurable intelligent surface co-existence in accordance with one or more aspects of the present disclosure.

### DETAILED DESCRIPTION

Wireless communication systems may deploy a reconfigurable intelligent surface (RIS) associated with or otherwise managed by a network entity. The RIS is generally a passive device including one or more reconfigurable reflective surfaces that reflect communications between a network entity and user equipment (UE). The RIS may be passive, but may support receiving a signal from its associated network entity (re) configuring the one or more reflective surfaces. Each reflective surface may therefore support reflecting the communications between the UE and network entity. Nevertheless, the reflective surfaces (or sub-RISs) may be configured to reflect beams to or from a certain direction. In other words, a RIS that includes four sub-RISs may reflect a message to or from one of four different directions (or beams).

In some circumstances (such as when a RIS is assisting in a network entity transmission of a synchronization system block (SSB)), the network entity may configure the RIS to sweep through its different beams when reflecting a message. Beam sweeping may also be used when a UE responds to the network entity after the UE has received an SSB. In order to indicate to the network entity which RIS beam the UE is using for its response, the RIS may be configured to add a watermark to the reflections associated with different RIS beams. The watermark may include a phase, time, and/or frequency change (generally referred to as a phase-change pattern) that is introduced into the reflected signal by the RIS (or sub-RIS). That is, any wireless signal hitting the RIS may be reflected in a different direction, which may also introduce a watermarking effect onto the reflected signal, which may generally be referred to as the phase-change pattern.

While such techniques may be helpful for the communications between the UE and network entity, the introduction of a watermarking phase-change pattern by the RIS may introduce channel estimation errors for other UEs and/or network entities whose communications are via the RIS when the other UEs or network entityies are not aware of the watermarking pattern applied by the RIS.

Generally, the described techniques provide various mechanisms supporting a UE and/or network entity to detect that a RIS is using a watermarking or phase-change pattern (e.g., a RIS that is configured by some other network entity that is associated with the same or a different network operator). In one proposal, a network entity learns of the watermarking pattern applied by the RIS through communications with another device (the other network entity managing the RIS and/or a UE communicating via the RIS) that is already aware of the watermarking pattern. The network entity then sends an explicit indication of the pattern to its UEs so that the UEs may adjust (via time or phase) transmissions accordingly. In a second proposal, the network entity may transmit one or more reference signal(s) (RS) (s) (e.g., a new reference signal and/or a modified phase tracking reference signal (PT-RS)) to a UE. The reference signal is received at the UE via the RIS. The UE will measure the reference signal and, if a phase change pattern is detected, the UE will determine that the RIS is present and applying watermarking (e.g., phase, time, and/or frequency shifting of the signal), and the UE will be able to determine the pattern. The UE may report the phase-change pattern to the network entity. Accordingly, the UE and network entity may compensate for the RIS being deployed within the network for wireless communications by selecting, adjusting, or otherwise determining transmission parameters for the subsequent communications that mitigate the effects of the RIS watermarking.

Aspects of the disclosure are initially described in the context of wireless communications systems. Aspects of the disclosure are further illustrated by and described with reference to apparatus diagrams, system diagrams, and flowcharts that relate to RIS co-existence.

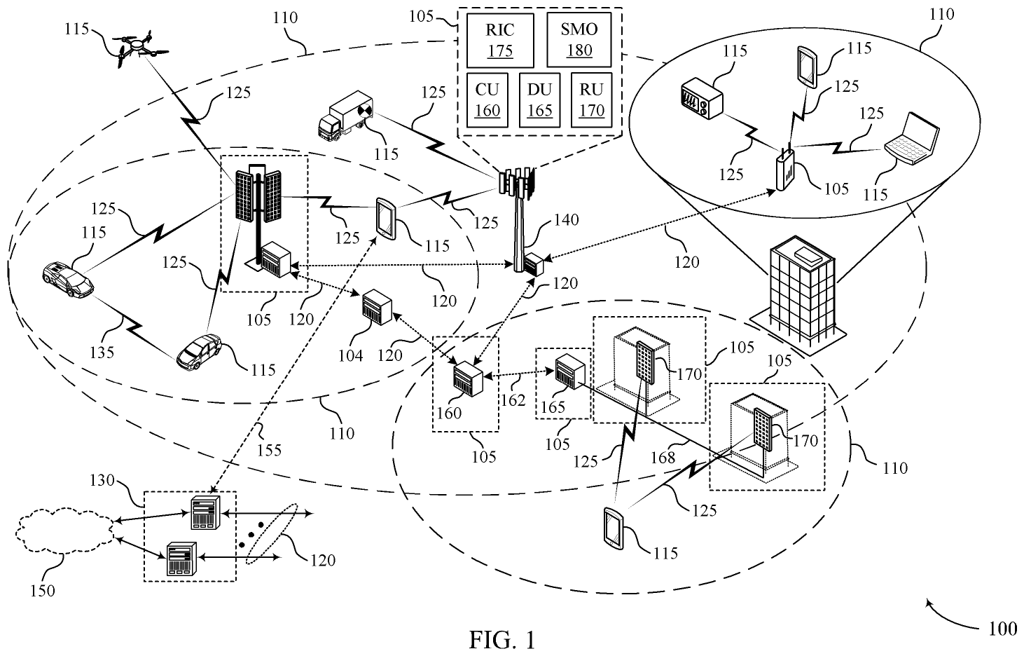

FIG. 1 illustrates an example of a wireless communications system 100 that supports RIS co-existence in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support RIS co-existence as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, a first wireless communications device (e.g., a UE 115 and/or network entity 105) may receive, from a second wireless communications device (e.g., a different UE 115 and/or network entity 105), a signal that is indicative of a phase-change pattern applied to communications between the first wireless communications device and the second wireless communications device by a RIS reflecting the communications. The first wireless communications device may determine the phase-change pattern from the signal. The first wireless communications device may transmit a message to the second wireless communications device, wherein at least one of a content or a transmission property of the message is based at least in part on the phase-change pattern.

In some aspects, a first wireless communications device (e.g., a UE 115 and/or network entity 105, which may refer to the second wireless communications devices discussed in the previous example above) may determine a phase-change pattern applied to communications between the first wireless communications device and a second wireless communications device (e.g., the first wireless communications device in the previous example above) by a RIS reflecting the communications. The first wireless communications device may transmit a message to the second wireless communications device indicative of the phase-change pattern, wherein at least one of a content or a transmission property is based at least in part on the phase-change pattern.

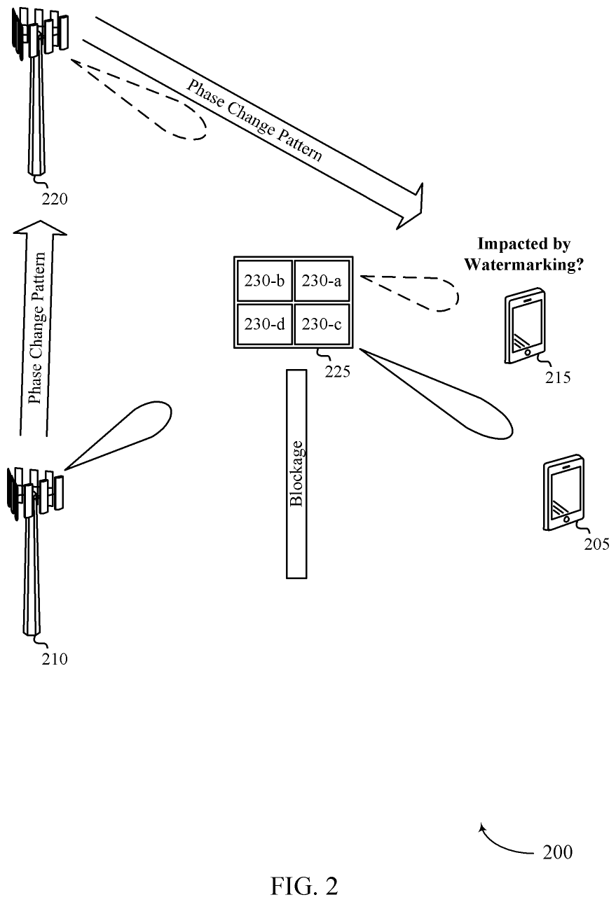

FIG. 2 illustrates an example of a wireless communication system 200 that supports RIS co-existence in accordance with aspects of the present disclosure. Wireless communication system 200 may include UE 205, network entity 210, UE 215, network entity 220, and RIS 225, which may be examples of the corresponding devices described herein. RIS 225 may include a set of RIS subpanels 230, with four RIS subpanels 230 being shown by way of example only (e.g., RIS subpanel 230-a, RIS subpanel 230-b, RIS subpanel 230-c, and RIS subpanel 230-d).

Wireless communication system 200 may support massive MIMO techniques to support increases in throughput. This may include high beamforming gains using active antenna units. This may include configuring individual radio frequency (RF) chains per antenna port. However, this approach may be associated with a significant increase in power consumption due to the use of the active antenna units (AAU).

Accordingly, wireless communication system 200 may include RIS 225, which may be employed within a wireless network to extend coverage (e.g., around a blockage), with negligible power consumption (e.g., as a substitute to AAU). RIS 225 may be a near passive device including the RIS subpanels 230. Each, some, or all RIS subpanels 230 may generally be configured to reflect an impinging wave to a desired direction. RIS 225 may include a receiver enabling network entity 210 to control the reflection direction of each RIS subpanel 230. For example, network entity 210 may transmit control signaling to RIS 225 indicating how each RIS subpanels 230 is to be configured.

That is, devices such as UE 205 and network entity 210 may leverage established communication links with RIS 225 that is coupled with or otherwise able to control the configuration of the reflective surface (e.g., RIS subpanels 230) to establish a communication link between the devices via the reflective surface. For example, RIS 225 may establish a communication link with each of two devices (e.g., UE 205 and network entity 210, in this example) via respective beam training procedures and RIS 225 may use information, such as beam directions or other characteristics, associated with directional beams that RIS 225 uses for communication with the two devices, as well as information associated with which of the two devices is transmitting to the other, to control a reflection characteristic of the reflective surface. In other words, RIS 225 may use information associated with a direction of signaling, such as a direction of signal reception (such as a receive beam direction) and/or a direction of signal transmission (such as a transmit beam direction) to determine or otherwise infer a direction of incident signaling at the reflective surface and a direction for reflected signaling from the reflective surface. RIS 225 accordingly may control the reflection characteristic of the reflective surface in accordance with the determined or inferred directions of incident and reflected signaling. In some aspects, RIS 225 may control the reflection characteristics of the reflective surface under to the control of network entity 210, which is the controlling, or otherwise associated with, RIS 225.

RIS 225 may introduce watermarking of the reflected signal, e.g., incidentally and/or in order to differentiate between beams reflected by RIS 225. In particular, by slowly changing the configuration of the RIS 225 over time, the reflected signal (e.g., beam) may be shifted in the frequency domain, in the time domain, and/or may introduce a phase shift into the reflected waveform (e.g., watermarked according to a phase-change pattern). For example, as network entity 210 transmits beams towards RIS 225, the RIS 225 adds (incidentally and/or specifically) the watermarking to the transmissions it reflects. In some examples, each RIS subpanel 230 may be configurable to apply a separate watermarking to each reflected beam. For example, a transmission from network entity 210 may be reflected from one or more RIS subpanels 230, with each RIS subpanel 230 introducing/adding a unique watermarking. Such watermarking may generally shift or otherwise change the center frequency of the SSB beam(s) being reflected from RIS 225.

However, in some scenarios other wireless communication devices proximate to RIS 225 may be performing wireless communications without being aware that RIS 225 is present (e.g., may be unaware of RIS 230). For example, UE 215 and network entity 220 may be performing wireless communications within an area such that the channel between UE 215 and network entity 220 may include, at least to some degree, RIS 225. Due to the location of network entity 220, UE 215, and RIS 225, transmissions from network entity 220 to UE 215 may be impacted by the presence of RIS 225, even though UE 215 and network entity 220 are unaware of the presence of RIS 225. As RIS 225 introduces watermarking into any impinging signal, this may create an issue for the channel between UE 215 and network entity 220. That is, the dynamic nature of (re) configuration of RIS 225 may be problematic for entities that are unaware of the RIS 225 configuration and/or even the presence of RIS 225.

As one non-limiting example, a demodulation reference signal (DMRS) transmission sent at symbol 0 with the corresponding data transmission sent at symbol 1 may be impacted when the configuration of RIS 225 changes between symbols 0 and 1. In this situation, the channel estimate based on the DMRS may not be usable for decoding the data transmission when the receiver is not aware of the presence and/or configuration of RIS 225.

Accordingly, aspects of the techniques described herein generally provide various mechanisms for wireless communication devices unaware of, but potentially impacted by, RIS 225 to detect the presence/configuration of RIS 225 (e.g., the phase-change pattern that is based on the configuration of RIS 225). That is, the techniques described herein provide mechanisms for wireless communication devices (such as UE 215 and/or network entity 220, in this example) to determine, identify, or otherwise discover the phase-change pattern of RIS 225 in order to mitigate any watermarking impacts on wireless communications between UE 215 and network entity 220.

Broadly, this may include a first wireless communications device (e.g., first device) receiving or otherwise obtaining a signal indicative of the phase-change pattern applied to communications by RIS 225 reflecting such communications. The first device may receive or otherwise obtain the signal from a second wireless communications device (e.g., second device). Generally, this may include wireless communications between the first and second devices being impacted by RIS 225. As discussed, RIS 225 may generally be managed by or otherwise associated with network entity 210 to perform wireless communications between network entity 210 and UE 205. Network entity 210 may (re) configure the phase-change pattern (e.g., (re) configure RIS subpanels 230) to redirect the reflected signal(s) to improve transmissions between UE 205 and network entity 210.

In the non-limiting example illustrated in FIG. 2, the first wireless communications device may generally refer to network entity 220 and the second wireless communications device may generally refer to network entity 210 and/or UE 205. For example, network entity 220 may exchange one or more messages (via a backhaul link and/or wireless messages exchanged over the channel) with network entity 210 regarding RIS 225. For example, network entity 220 and UE 215 may measure, identify, or otherwise determine that channel performance monitoring indicates the presence of a RIS device, such as RIS 225. This may include, but is not limited to, determining that the channel performance metrics changing according to a (pre) configured pattern or manner that indicates the presence of a RIS device within the channel.

For example, network entity 220 may exchange one or more wired and/or wireless messages with neighboring network entities (such as network entity 210, which may be consider the second device in this example) requesting information regarding deployed RIS devices. Network entity 210 (in this example) may respond with an indication that RIS 225 is present. In some aspects, network entity 210 may also include in the signal an indication of the phase-change pattern of RIS 225. The indication of the phase-change pattern of RIS 225 may include, but is not limited to, the (re) configuration of one, some, or all of the RIS subpanels 230, any semi-periodic and/or periodic patterns of the (re) configuration, capabilities of RIS 225, devices participating in the RIS-based communications, and the like. Accordingly, in this example network entity 220 may learn, identify, or otherwise determine the phase-change pattern of RIS 225 from the signal received from network entity 210 (in this example).

In another example, network entity 220 may again learn, identify, or otherwise determine the phase-change pattern of RIS 225 based on a signal received from network entity 210 (which may again be considered the second device in this example). For example, network entity 210 generally transmit (e.g., broadcast) parameters associated with its RIS-based communications with UE 205 for informational purposes to nearby devices. In this example, network entity 220 may receive the signal from UE 205 and determine the phase-change pattern of RIS 225 from the signal. Additionally, or alternatively, network entity 220 may monitor for (re) configuration signals from network entity 210 to RIS 225. As discussed, RIS 225 may be a passive device with no transmit capabilities, but may include receive capability enabling (re) configuration of RIS 225 by network entity 210. Network entity 220 may be aware (e.g., configured by the core network, network operator, etc.) of such (re) configuration signaling from network entity 210 and therefore monitor for such signaling (e.g., monitor resources associated with such signaling). Network entity 220 may learn, identify, or otherwise determine the phase-change pattern of RIS 225 based on detecting the (re) configuration signaling.

In another example, network entity 220 may learn, identify, or otherwise determine the phase-change pattern of RIS 225 based on a signal received from UE 205 (which may be considered the second device in this example). For example, UE 205 may be independent of network entity 220, but may generally transmit (e.g., broadcast) parameters associated with its RIS-based communications for informational purposes to nearby devices. In this example, network entity 220 may receive the signal from UE 205 and determine the phase-change pattern of RIS 225.

In another example, network entity 220 may again learn, identify, or otherwise determine the phase-change pattern of RIS 225 based on a signal received from UE 205 (which may again be considered the second device in this example). For example, UE 205 may be associated with network entity 220, such as in a dual-connectivity scenario where UE 205 is connected to an LTE network entity as well as to a NR network entity (e.g., when network entity 210 and network entity 220 are associated with different radio access technologies). In another dual-connectivity example, UE 205 may have a control plane established with network entity 220 and a user-plane established with network entity 210, or vice versa. Accordingly, UE 205 in this example may be aware of the RIS-based communications with network entity 210 as well as aware that network entity 220 may not be aware of the RIS-based communications. Accordingly, UE 205 may generally transmit (e.g., unicast) parameters associated with its RIS-based communications for informational purposes to network entity 220. In this example, network entity 220 may receive the signal from UE 205 and determine the phase-change pattern of RIS 225. In some aspects of this example, network entity 220 may transmit a request for RIS-based information from any associated UE, with UE 205 transmitting the signal indicating the phase-change pattern of RIS 225 in response.

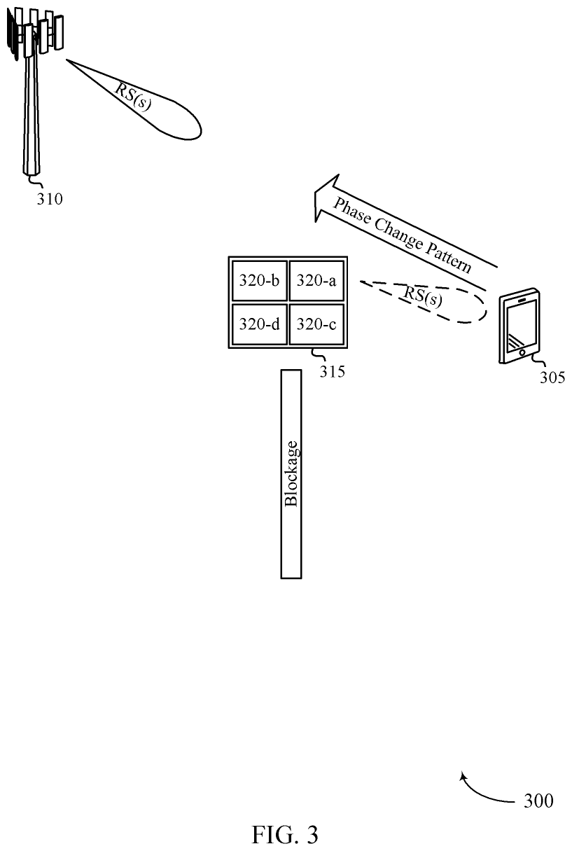

In some examples, UE 205 may have learned the phase-change pattern of RIS 225 according to the techniques discussed with respect to FIGS. 3-5, and indicate the phase-change pattern of RIS 225 in the signal to network entity 220.

In another example, network entity 220 may receive the signal from a network entity carrying, conveying, or otherwise indicative of the phase-change pattern of RIS 225. For example, one or more core network entities (e.g., an access and management function (AMF), mobility management entity (MME), and the like, which would be considered the second wireless communications device in this example) may identify or otherwise determine that RIS 225 is deployed in a location that could potentially impact wireless communications between UE 215 and network entity 220. This may include the core network entity learning or the presence/configuration of RIS 225 based on network entity 210 being associated with the core network, based on the core network entity exchanging one or more messages with a companion core network entity of a different network operator, and the like. The core network entity may transmit the signal (e.g., via backhaul link, such as an S1 link) to network entity 220. In this example, network entity 220 may receive the signal from the core network entity and determine the phase-change pattern of RIS 225.

Network entity 220 may, in this example, then transmit a message to a second wireless device (which would be UE 215 in this context) in response to learning, identifying, or otherwise determining the phase-change pattern of RIS 225. Broadly, the content and/or transmission property of the message may be based on the phase-change pattern. That is, in the non-limiting example illustrated in FIG. 2, the message from network entity 220 and UE 215 may carry or otherwise convey one or more bits, fields, information elements, flags, indices, and the like (e.g., the content), an indication of the phase-change pattern of RIS 225. As discussed above, the phase-change pattern of RIS 225 may generally include (re) configuration parameters (e.g., the watermarking pattern), timing aspects of the semi-periodic or periodic nature of such (re) configurations (e.g., at the symbol or slot level pattern), and the like. Accordingly, UE 215 may learn, identify, or otherwise determine the phase-change pattern of RIS 225. In response, network entity 220 and UE 215 may adjust various transmission properties used for subsequent communications based on the phase-change pattern. For example, network entity 220 and/or UE 215 may adjust the phase, the timing, the frequency, the spatial, etc., parameters used for the subsequent communications to mitigate any negative impact of RIS 225.

Accordingly, wireless communications system 200 illustrates one non-limiting example of the techniques described herein where network entity 220 explicitly informs UE 215 of the RIS watermarking pattern. Network entity 220 may have learned the phase-change pattern directly from another operator controlling RIS 225, based on measurements carried out by a different UE (e.g., UE 205 in this example), and/or based on a reference signal transmitted by a UE (e.g., UE 205 and/or UE 215). Network entity 220 may transmit the message to UE 215 indicating the phase-change pattern of RIS 225 via a downlink control information (DCI) message, a medium access control-control element (MAC-CE), and the like. The indicated phase-change pattern may include an indication of the symbol(s)/slot(s) during which watermarking will occur, the watermarking pattern(s) that will (potentially) be used by RIS 225, and the like. Network entity 220 and/or UE 215 may compensate for the watermarking pattern to improve transmissions between devices and/or to improve decoding of the subsequent communications (e.g., to recover a cleaner signal).

FIG. 3 illustrates an example of a wireless communication system 300 that supports RIS co-existence in accordance with aspects of the present disclosure. Wireless communication system 300 may include UE 305, network entity 310, and RIS 315, which may be examples of the corresponding devices described herein. RIS 315 may include a set of RIS subpanels 320, with four RIS subpanels 320 being shown by way of example only (e.g., RIS subpanel 320-a, RIS subpanel 320-b, RIS subpanel 320-c, and RIS subpanel 320-d).

Wireless communication system 300 is similar to wireless communication system 200 in that RIS 315 may be used for other wireless devices within the network (not shown). However, the presence and/or (re) configuration of RIS 315 is generally unknown by UE 305 and network entity 310. However, the watermarking pattern (e.g., phase-change pattern) of RIS 315 may impact wireless communications between UE 305 and network entity 310. Accordingly, it may be beneficial for UE 305 and/or network entity 310 to learn, identify, or otherwise determine the phase-change pattern of RIS 315 in order to mitigate the effects of any watermarking.

However, wireless communications system 300 illustrates another example of techniques for UE 305 and/or network entity 310 to determine the phase-change pattern of RIS 315. Broadly, this example includes network entity 310 transmitting a reference signal (RS) to UE 305, which UE 305 uses to measure the phase-change pattern (e.g., using channel estimation techniques) of RIS 315. UE 305 then informs network entity 310 of the phase-change pattern. Although these techniques are described as network entity 310 transmitting the RS to UE 305 and UE 305 determining and indicating the phase-change pattern, it is to be understood that these techniques may also be applied where UE 305 transmits the RS and network entity 310 determines the phase-change pattern of RIS 315. Network entity 310, in this example, may then transmit a message to UE 305 indicating the phase-change pattern of RIS 315 (e.g., to improve uplink communication transmissions mitigating the watermarking effect).

In this example, aspects of the techniques described herein generally provide various mechanisms for wireless communication devices unaware of, but potentially impacted by, RIS 315 to detect the presence/configuration of RIS 315 (e.g., the phase-change pattern that is based on the configuration of RIS 315). That is, the techniques described herein provide mechanisms for wireless communication devices (such as UE 305 and/or network entity 310, in this example) to determine, identify, or otherwise discover the phase-change pattern of RIS 315 in order to mitigate any watermarking impacts on wireless communications between UE 305 and network entity 310.

Broadly, this may include a first wireless communications device (e.g., first device) receiving or otherwise obtaining a signal indicative of the phase-change pattern applied to communications by RIS 315 reflecting such communications. The first device may receive or otherwise obtain the signal from a second wireless communications device (e.g., second device). Generally, this may include wireless communications between the first and second devices being impacted by RIS 315.

In the non-limiting example illustrated in FIG. 3, the first wireless communications device may generally refer to network entity 310 and the second wireless communications device may generally refer to UE 305. For example, network entity 310 may transmit or otherwise convey a signal (e.g., the RS(s)) to UE 305 where the RIS 315 applies the phase-change pattern to the signal (e.g., the RS(s)). Accordingly, the signal received from network entity 310 will be watermarked (e.g., shifted in time, frequency, and/or phase according to the phase change pattern).

The first device (e.g., UE 305, in this example) may measure, identify, or otherwise determine the phase-change pattern from the signal (e.g., the RS(s)). For example, UE 305 may perform a set of channel measurements using the signal over a given time period. That is, UE 305 may perform a channel measurement on each RS transmitted by network entity 310 and reflected by RIS 315 over a given time period and/or for a given number of RSs. Accordingly, UE 305 may observe the channel estimation across time. The set of channel estimation measurements may provide an indication of whether RIS 315 is present and, if so, whether RIS 315 is performing watermarking.

In some examples, UE 305 determines that RIS 315 is present and is performing watermarking. UE 305 may use the set of channel estimation measurements to identify or otherwise determine the phase-change pattern of RIS 315. In some examples, the watermarking performed by RIS 315 may follow a specific pattern (e.g., a standardized pattern) that is known by operators (e.g., network entity(s)) and/or UE(s). For example, UE 305 may compare the set of channel estimation measurements (e.g., the results) to each of a plurality of available sets of phase-change patterns. In some aspects, UE 305 may learn, measure, or otherwise determine the phase-change pattern of RIS 315 by comparing the channel variation across time with a table of permissible watermarking patterns. In some aspects, this may include network entity 310 transmitting or otherwise providing (and UE 305 receiving or otherwise obtaining) a configuration signal (e.g., DCI, MAC-CE, radio resource control (RRC) signal, etc.) identifying the available sets of phase-change patterns. Each phase-change pattern included in the available sets of phase-change patterns may include a unique symbol/slot pattern for the phase-change pattern and/or the watermarking pattern for the RIS 315. Accordingly, UE 305 may identify or otherwise determine the phase-change pattern of RIS 315 based on the comparing.

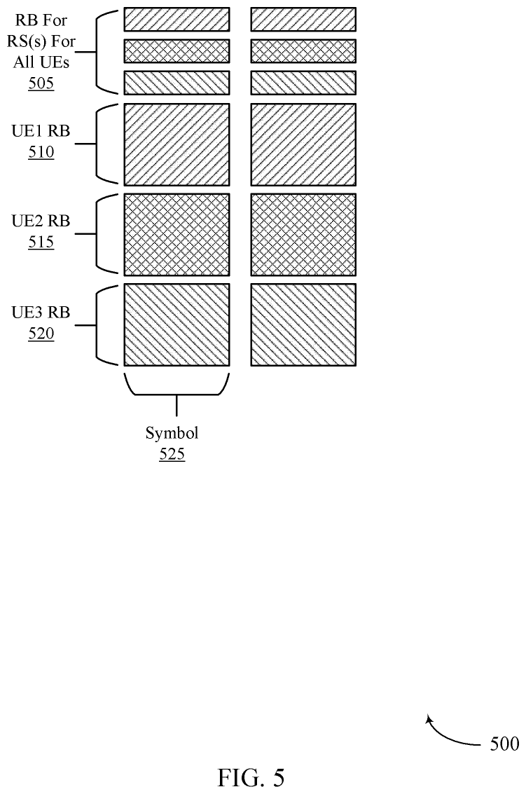

In some examples, the RS transmitted by network entity 310 may include a new RS (e.g., a newly introduced RS used for RIS detection and tracking) and/or a repurposed reference signal (e.g., a CSI-RS, DMRS, beam management/tracking RS, a location tracking RS, a phase-tracking RS (PT-RS), and the like). In the example where an existing RS is used, various aspects of the techniques described herein may include such repurposing. For example, in some network the PT-RS may only be defined for a subset of channels, such as a physical uplink shared channel (PUSCH), physical downlink shared channel (PDSCH), and/or physical sidelink shared channel (PSSCH) (e.g., uplink, downlink, and/or sidelink data channels). Accordingly, aspects of the techniques described herein may include supporting PT-RS transmissions on other channels, such as a physical uplink control channel (PUCCH), a physical downlink control channel (PDCCH), and/or a physical sidelink control channel (PSCCH) (e.g., uplink, downlink, and/or sidelink control channels). In an example discussed with reference to FIG. 5, in some aspects the PT-RS may not necessarily be limited to the allocated band(s) for data/control transmissions. For example, the PT-RS may be received in a first subband that is different from a second subband configured for data and/or control communications (e.g., one tone per-physical resource block (PRB) and/or per-resource block group (RBG)).

UE 305 may, in this example, then transmit a message to a second wireless device (which would be network entity 310 in this context) in response to learning, identifying, or otherwise determining the phase-change pattern of RIS 315. Broadly, the content and/or transmission property of the message may be based on the phase-change pattern. That is, in the non-limiting example illustrated in FIG. 3, the message from UE 305 may carry or otherwise convey one or more bits, fields, information elements, flags, indices, and the like (e.g., the content), an indication of the phase-change pattern of RIS 315. As discussed above, the phase-change pattern of RIS 315 may generally include (re) configuration parameters (e.g., the watermarking pattern), timing aspects of the semi-periodic or periodic nature of such (re) configurations (e.g., at the symbol or slot level pattern), and the like. Accordingly, UE 305 may learn, identify, or otherwise determine the phase-change pattern of RIS 315 and report the phase-change pattern to network entity 310. In response, network entity 310 and UE 305 may adjust various transmission properties used for subsequent communications based on the phase-change pattern. For example, network entity 310 and/or UE 305 may adjust the phase, the timing, the frequency, the spatial, etc., parameters used for the subsequent communications to mitigate any negative impact of RIS 315.

Accordingly, wireless communications system 300 illustrates one non-limiting example of the techniques described herein where network entity 310 transmits RS(s) to UE 305 that are impacted by the RIS watermarking pattern. UE 305 may measure the RS(s) from network entity 310 and use these measurements to identify or otherwise determine the phase-change pattern of RIS. 315. UE 305 may transmit the message to network entity 310 indicating the phase-change pattern of RIS 315. The indicated phase-change pattern may include an indication of the symbol(s)/slot(s) during which watermarking will occur, the watermarking pattern(s) that will (potentially) be used by RIS 315, and the like. Network entity 310 and/or UE 305 may compensate for the watermarking pattern to improve transmissions between devices and/or to improve decoding of the subsequent communications (e.g., to recover a cleaner signal).

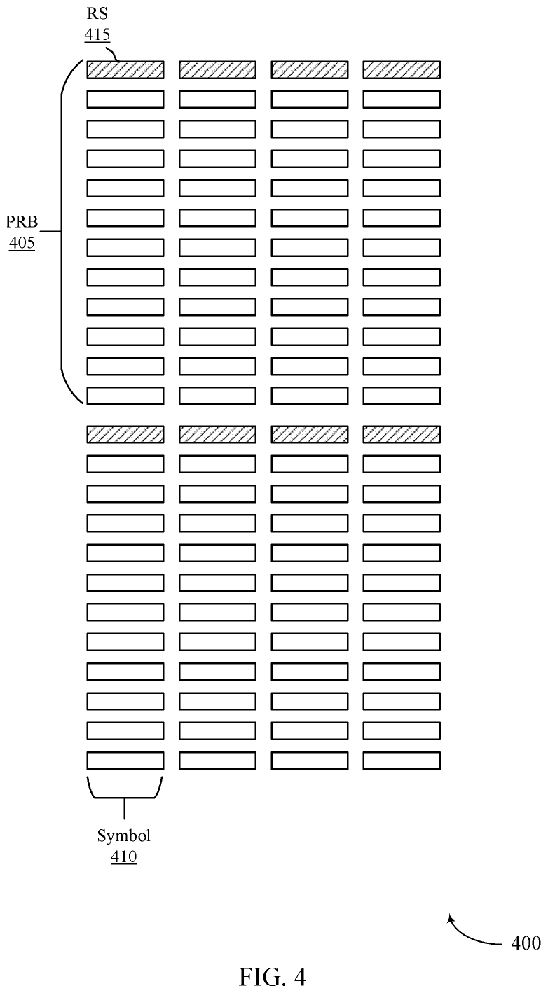

FIG. 4 illustrates an example of a RS configuration 400 that supports RIS co-existence in accordance with aspects of the present disclosure. Aspects of RS configuration 400 may be implemented at or implemented by a UE, network entity, and/or RIS, which may be examples of the corresponding devices described herein.

As discussed above, aspects of the techniques discussed herein provide various mechanisms for wireless communications devices within a wireless network to detect the presence and/or phase-change pattern of a RIS implemented within the network. For example, some wireless devices within a network may be unaware of the RIS deployment within the network, even though the RIS performing watermarking operations may impact wireless communications between such devices.

Accordingly, a first device may receive a signal from a second device that is indicative of the phase-change pattern being applied to wireless communications between the devices by the RIS reflecting the communications. RS configuration 400 illustrates an example where the signal is a RS 415 transmitted during one or more symbols 410 within a (mini-) slot. The RS 415 may generally be transmitted on a one-tone per-PRB (e.g., for each PRB 405) and/or on a one-tone per-PRG basis. In this non-limiting example, the RS 415 may have a rather low density in the frequency domain, but may span multiple symbols 410 or slots.

The second device may generally perform a set of channel estimation measurements using the RS 415 transmissions. For example, the second device may measure the RS 415 during each symbol 410 of the (mini-) slot. The second device may compare the set of channel estimation measurements to each of a plurality of available sets of phase-change patterns to identify the phase-change pattern. The second device may transmit or otherwise provide a message back to the first device where the content is based on the phase-change pattern. In the non-limiting example illustrated in RS configuration 400, this may include the second device configuring the content of the message to carry or otherwise convey an indication of the phase-change pattern. Accordingly, the first and second devices may adjust various properties of subsequent communications (e.g., transmission and/or reception properties) to mitigate any impact caused by the watermarking operations of the RIS.

FIG. 5 illustrates an example of a RS configuration 500 that supports RIS co-existence in accordance with aspects of the present disclosure. Aspects of RS configuration 500 may be implemented at or implemented by a UE, network entity, and/or RIS, which may be examples of the corresponding devices described herein.

As discussed above, aspects of the techniques discussed herein provide various mechanisms for wireless communications devices within a wireless network to detect the presence and/or phase-change pattern of a RIS implemented within the network. For example, some wireless devices within a network may be unaware of the RIS deployment within the network, even though the RIS performing watermarking operations may impact wireless communications between such devices.

Accordingly, a first device may receive a signal from a second device that is indicative of the phase-change pattern being applied to wireless communications between the devices by the RIS reflecting the communications. RS configuration 500 illustrates an example where the signal is a RS transmitted during one or more symbols 525 within a (mini-) slot. As discussed above, the RS may generally be transmitted on a one-tone per-PRB and/or on a one-tone per-PRG basis. In this non-limiting example, the RS may be transmitted on separate subbands than the corresponding data/control transmissions. For example, the RS may be a PT-RS received in a first subband (e.g., RB 505 configured for RSs for all UEs) different from a second subband (e.g., RB 510 configured for UE 1, RB 515 configured for UE 2, and RB 520 configured for UE 3) configured for data and/or control communications. That is, one tone of RB 505 may be configured for UE 1 to receive RS transmissions from another device for phase-change measurement and determination while the tones of RB 510 are configured for data and/or control communications involving UE 1. Similarly, a second tone of RB 505 may be for UE 2 to receive RS transmissions from another device for phase-change measurement and determination while the tones of RB 515 are configured for data and/or control communications involving UE 2. Lastly, a third tone of RB 505 may be for UE 3 to receive RS transmissions from another device for phase-change measurement and determination while the tones of RB 520 are configured for data and/or control communications involving UE 3.

Accordingly, RS configuration 500 illustrates an example where advantages of the wide-band configuration of the RIS can be leveraged to support the PT-RS and the impacted channel (e.g., communications using RB 510, RB 515, and/or RB 520 being impacted by watermarking operations of a RIS) to be on different subbands. In some examples, this may be leveraged when multiplexing certain UEs, such as low-overhead UEs.

The second device may generally perform a set of channel estimation measurements using the RS transmissions. For example, the second device may measure the RS during each symbol 525 of the (mini-) slot. The second device may compare the set of channel estimation measurements to each of a plurality of available sets of phase-change patterns to identify the phase-change pattern. The second device may transmit or otherwise provide a message back to the first device where the content is based on the phase-change pattern. In the non-limiting example illustrated in RS configuration 500, this may include the second device configuring the content of the message to carry or otherwise convey an indication of the phase-change pattern. Accordingly, the first and second devices may adjust various properties of subsequent communications (e.g., transmission and/or reception properties) to mitigate any impact caused by the watermarking operations of the RIS.

That is, in some examples the UE may use the watermarking learned according to these techniques to correct the channel in the future transmissions (e.g., to adjust transmission and/or reception parameters used for the subsequent communications to mitigate the watermarking effect). This may reduce the number of RS transmissions, thus conserving resources. In some aspects, this may be based on an understanding that the operations of the RIS are regulated (e.g., according to a periodic schedule). For example, a RIS may be (re) configured (e.g., required) to apply a watermarking pattern every N (mini-) slots. The watermarking learned during slot K (e.g., the phase-change pattern determined according to the techniques described herein) may be used to correct the channel during slot N+K. Additionally, or alternatively, multiple watermarking detection/quantization techniques may be leveraged (e.g., combined) to improve future watermarking detection/quantization operations.

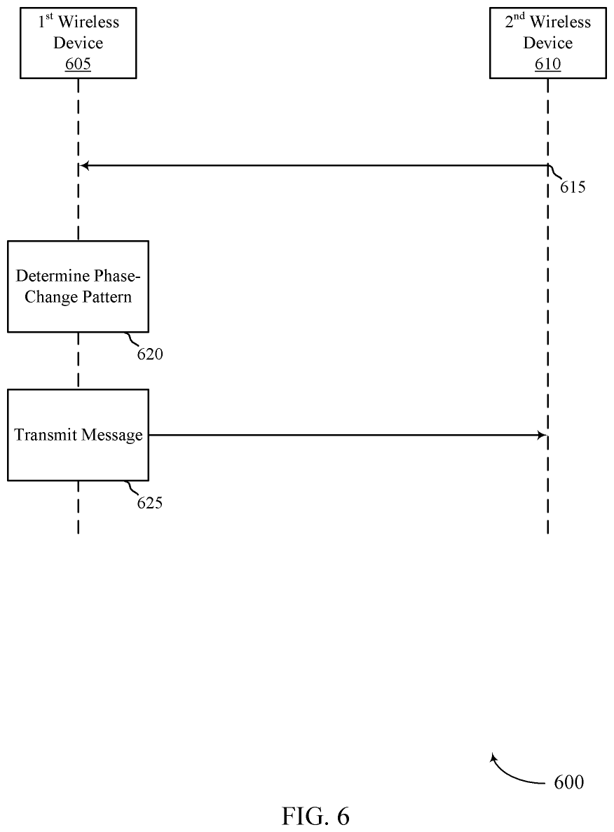

FIG. 6 illustrates an example of a process 600 that supports RIS co-existence in accordance with aspects of the present disclosure. Process 600 may implement aspects of wireless communication systems 100, 200 and/or 300, and/or aspects of RS configurations 400 and/or 500. Aspects of process 600 may be implemented at or implemented by a first wireless communications device (e.g., first device 605) and/or a second wireless communications device (e.g., second device 610), which may be examples of a UE and/or network entity as described herein.

At 615, the first device 605 may receive or otherwise obtain (and the second device 610 may transmit or otherwise provide) a signal that is indicative of a phase-change pattern applied to communications between the first and second devices, between the first device and another device, and/or between the second device and another device. The phase-change pattern may generally be applied to the signal by a RIS reflecting the communications.

At 620, the first device 605 may identify or otherwise determine the phase-change pattern of the RIS based at least in part on the signal.

In some examples, this may include the first device 605 receiving an indication of the phase-change pattern of the RIS in the signal. For example, the second device 610 may coordinate with one or more other wireless devices (e.g., a third wireless communications device), such as a nearby network entity and/or UE, a core network entity, and the like, to determine the phase-change pattern of the RIS. The second device 610 may configure one or more bits, fields, information elements, etc., in the signal to identify the phase-change pattern for the first device 605. This may include an indication of a symbol and/or slot pattern for the phase-change pattern, a watermarking pattern of the RIS, a periodicity associated with the phase-change pattern, and the like.

In some examples, the signal received from the second device 610 may be a RS, such as a new RS used for phase-change pattern measurements and/or a PT-RS or any other repurposed RS. The RS may be received over uplink, downlink, and/or sidelink data and/or control channels. The RS may be received in a different subband than the subband configured for data and/or control communications involving the first device 605. The RS may be reflected from the RIS according to the watermarking operations of the RIS, thus imprinting its phase-change pattern onto the signal. The first device 605 may determine the phase-change pattern by performing a set of channel estimation measurements using the signal over a time period (e.g., a certain number of symbols/slots). In some examples, the first device 605 may be configured with a plurality of available sets of phase-change patterns and may identify the phase-change pattern by comparing the set of channel estimation measurements to each phase-change pattern in the available sets of phase-change patterns.

In some examples, this may include the first device 605 identifying or otherwise determining the periodicity for the phase-change pattern. In this example, the first device 605 may determine the phase change pattern by performing a set of channel estimation measurements using the plurality of signals, where each signal is received during different periodic instances of the phase-change pattern in accordance with the periodicity.

At 625, the first device 605 may transmit or otherwise provide (and the second device 610 may receive or otherwise obtain) a message. Generally, a content and/or transmission property of the message may be based, at least to some degree, on the phase-change pattern of the RIS. In examples where the first device 605 determines the phase-change pattern using RS transmissions, the content of the message may carry or otherwise convey an indication of the phase-change pattern determined by the first device 605. In examples where the first device 605 determines the phase-change pattern based on an indication in the signal received at 615, the transmission property of the message may be based on the phase-change pattern. For example, the first device 605 may adjust transmission properties during subsequent communications, such as the timing, the frequency, the phase, and the like, alone or in any combination, to compensate for the watermarking operations of the RIS.

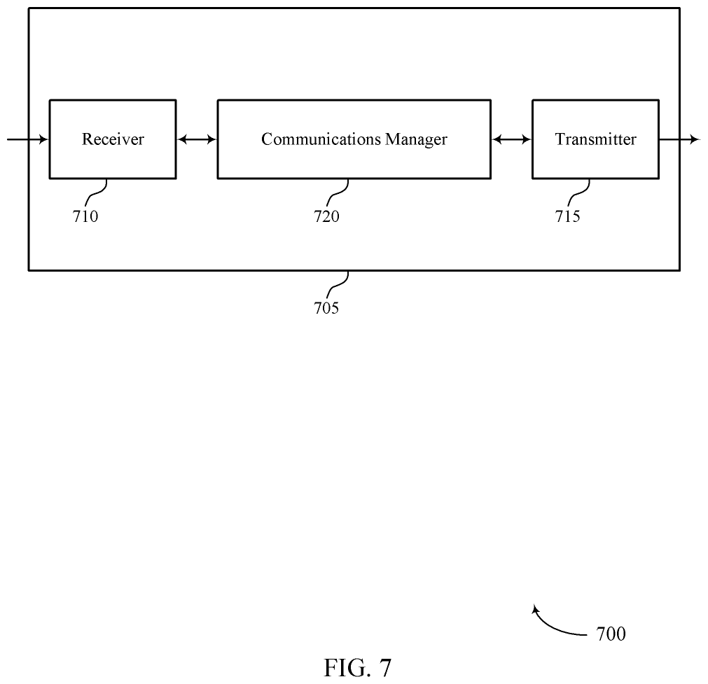

FIG. 7 shows a block diagram 700 of a device 705 that supports RIS co-existence in accordance with one or more aspects of the present disclosure. The device 705 may be an example of aspects of a UE 115 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RIS co-existence). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RIS co-existence). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of RIS co-existence as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first wireless communications device in accordance with examples as disclosed herein. For example, the communications manager 720 may be configured as or otherwise support a means for receiving, from a second wireless communications device, a signal that is indicative of a phase-change pattern applied to communications between the first wireless communications device and the second wireless communications device by a RIS reflecting the communications. The communications manager 720 may be configured as or otherwise support a means for determining the phase-change pattern from the signal. The communications manager 720 may be configured as or otherwise support a means for transmitting a message to the second wireless communications device, where at least one of a content or a transmission property of the message is based on the phase-change pattern.

Additionally, or alternatively, the communications manager 720 may support wireless communication at a first wireless communications device in accordance with examples as disclosed herein. For example, the communications manager 720 may be configured as or otherwise support a means for determining a phase-change pattern applied to communications between the first wireless communications device and a second wireless communications device by a RIS reflecting the communications. The communications manager 720 may be configured as or otherwise support a means for transmitting a message to the second wireless communications device indicative of the phase-change pattern, where at least one of a content or a transmission property is based on the phase-change pattern.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for improving wireless communications between devices operating in the vicinity of a RIS. The devices may exchange signal(s) and/or message(s) to detect the presence of a RIS and/or quantify the watermarking operations (e.g., phase-change pattern) of the RIS.

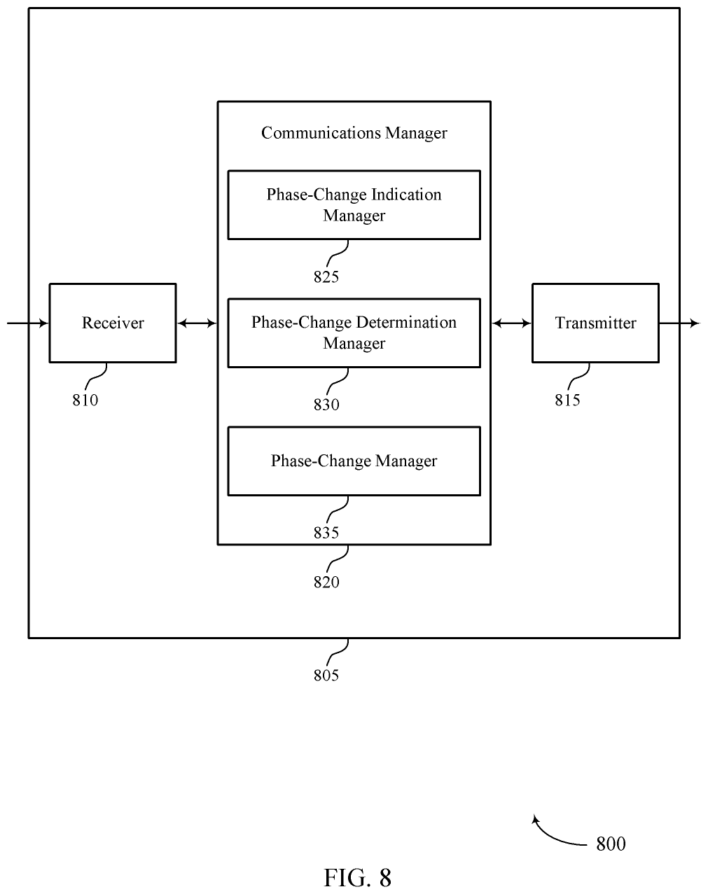

FIG. 8 shows a block diagram 800 of a device 805 that supports RIS co-existence in accordance with one or more aspects of the present disclosure. The device 805 may be an example of aspects of a device 705, a UE 115, or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to RIS co-existence). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to RIS co-existence). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of RIS co-existence as described herein. For example, the communications manager 820 may include a phase-change indication manager 825, a phase-change determination manager 830, a phase-change manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first wireless communications device in accordance with examples as disclosed herein. The phase-change indication manager 825 may be configured as or otherwise support a means for receiving, from a second wireless communications device, a signal that is indicative of a phase-change pattern applied to communications between the first wireless communications device and the second wireless communications device by a RIS reflecting the communications. The phase-change determination manager 830 may be configured as or otherwise support a means for determining the phase-change pattern from the signal. The phase-change manager 835 may be configured as or otherwise support a means for transmitting a message to the second wireless communications device, where at least one of a content or a transmission property of the message is based on the phase-change pattern.

Additionally, or alternatively, the communications manager 820 may support wireless communication at a first wireless communications device in accordance with examples as disclosed herein. The phase-change determination manager 830 may be configured as or otherwise support a means for determining a phase-change pattern applied to communications between the first wireless communications device and a second wireless communications device by a RIS reflecting the communications. The phase-change indication manager 825 may be configured as or otherwise support a means for transmitting a message to the second wireless communications device indicative of the phase-change pattern, where at least one of a content or a transmission property is based on the phase-change pattern.

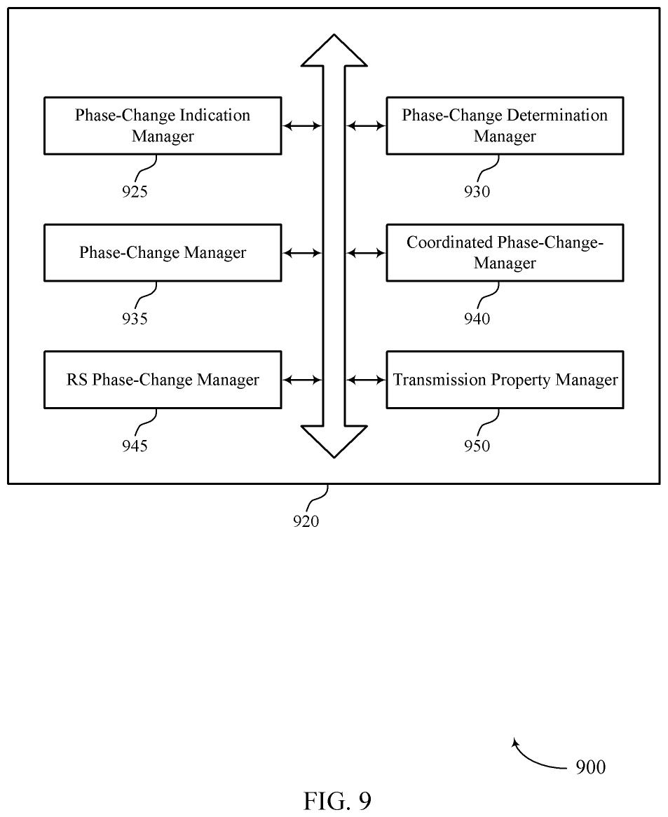

FIG. 9 shows a block diagram 900 of a communications manager 920 that supports RIS co-existence in accordance with one or more aspects of the present disclosure. The communications manager 920 may be an example of aspects of a communications manager 720, a communications manager 820, or both, as described herein. The communications manager 920, or various components thereof, may be an example of means for performing various aspects of RIS co-existence as described herein. For example, the communications manager 920 may include a phase-change indication manager 925, a phase-change determination manager 930, a phase-change manager 935, a coordinated phase-change-manager 940, an RS phase-change manager 945, a transmission property manager 950, or any combination thereof. Each of these components may communicate, directly or indirectly, with one another (e.g., via one or more buses).

The communications manager 920 may support wireless communication at a first wireless communications device in accordance with examples as disclosed herein. The phase-change indication manager 925 may be configured as or otherwise support a means for receiving, from a second wireless communications device, a signal that is indicative of a phase-change pattern applied to communications between the first wireless communications device and the second wireless communications device by a RIS reflecting the communications. The phase-change determination manager 930 may be configured as or otherwise support a means for determining the phase-change pattern from the signal. The phase-change manager 935 may be configured as or otherwise support a means for transmitting a message to the second wireless communications device, where at least one of a content or a transmission property of the message is based on the phase-change pattern.

In some examples, to support determining the phase-change pattern, the coordinated phase-change-manager 940 may be configured as or otherwise support a means for receiving an indication of the phase-change pattern in the signal, where determining the phase-change pattern is based on the indication. In some examples, the indication of the phase-change pattern includes a symbol or slot pattern for the phase-change pattern, a watermarking pattern for the RIS, or both.

In some examples, to support determining the phase-change pattern, the RS phase-change manager 945 may be configured as or otherwise support a means for performing a set of channel estimation measurements using the signal over a time period. In some examples, to support determining the phase-change pattern, the RS phase-change manager 945 may be configured as or otherwise support a means for comparing the set of channel estimation measurements to each of a set of multiple available sets of phase-change patterns. In some examples, to support determining the phase-change pattern, the RS phase-change manager 945 may be configured as or otherwise support a means for identifying the phase-change pattern from the available sets of phase-change patterns based on the comparing.

In some examples, the RS phase-change manager 945 may be configured as or otherwise support a means for receiving, from the second wireless communications device, a configuration signal identifying the available sets of phase-change patterns, where the configuration signal includes a downlink control information, a medium access control-control element, a radio resource control, or any combination thereof.

In some examples, each phase-change pattern in the available sets of phase-change patterns is associated with a symbol or slot pattern for the phase-change pattern, a watermarking pattern for the RIS, or a combination thereof. In some examples, the signal includes a reference signal used for RIS detection and tracking, a phase-tracking reference signal, or both. In some examples, the signal including the phase-tracking reference signal is received in an uplink control channel, a downlink control channel, or both. In some examples, the signal including the phase-tracking reference signal is received in a first subband that is different from a second subband configured for data communications between the first wireless communications device and the second wireless communications device. In some examples, the signal is received via one tone per-physical resource block or per-resource block group configured for the first wireless communications device.

In some examples, to support performing the set of channel estimation measurements using the signal over the time period, the RS phase-change manager 945 may be configured as or otherwise support a means for identifying a periodicity for the phase-change pattern. In some examples, to support performing the set of channel estimation measurements using the signal over the time period, the RS phase-change manager 945 may be configured as or otherwise support a means for performing a set of channel estimation measurements using a set of multiple signals, each received during different periodic instances of the phase-change pattern in accordance with the periodicity.

In some examples, the transmission property manager 950 may be configured as or otherwise support a means for adjusting, based on the phase-change pattern, the transmission property during subsequent communications between the first wireless communications device and the second wireless communications device, where the transmission property includes a phase, a timing, a frequency, or any combination thereof.

In some examples, the phase-change indication manager 925 may be configured as or otherwise support a means for configuring the content of the message to indicate the phase-change pattern.

Additionally, or alternatively, the communications manager 920 may support wireless communication at a first wireless communications device in accordance with examples as disclosed herein. In some examples, the phase-change determination manager 930 may be configured as or otherwise support a means for determining a phase-change pattern applied to communications between the first wireless communications device and a second wireless communications device by a RIS reflecting the communications. In some examples, the phase-change indication manager 925 may be configured as or otherwise support a means for transmitting a message to the second wireless communications device indicative of the phase-change pattern, where at least one of a content or a transmission property is based on the phase-change pattern.

In some examples, to support determining the phase-change pattern, the coordinated phase-change-manager 940 may be configured as or otherwise support a means for receiving, from a third wireless communications device, an indication of the phase-change pattern, where the message transmitted to the second wireless communications device includes the indication of the phase-change pattern. In some examples, the indication of the phase-change pattern includes a symbol or slot pattern for the phase-change pattern, a watermarking pattern for the RIS, or both. In some examples, the third wireless communications device includes a network entity associated with the RIS, a UE associated with the first wireless communications device, or both.

In some examples, to support determining the phase-change pattern, the RS phase-change manager 945 may be configured as or otherwise support a means for transmitting, to the second wireless communications device, a signal to which the phase-change pattern is applied by the RIS. In some examples, to support determining the phase-change pattern, the RS phase-change manager 945 may be configured as or otherwise support a means for receiving an indication of the phase-change pattern from the second wireless communications device, where the indication is based on measurements of the signal.

In some examples, the RS phase-change manager 945 may be configured as or otherwise support a means for transmitting, to the second wireless communications device, a configuration signal identifying available sets of phase-change patterns, where the configuration signal includes a downlink control information, a medium access control-control element, a radio resource control, or any combination thereof.

In some examples, each phase-change pattern in the available sets of phase-change patterns is associated with a symbol or slot pattern for the phase-change pattern, a watermarking pattern for the RIS, or a combination thereof. In some examples, the signal includes a reference signal used for RIS detection and tracking, a phase-tracking reference signal, or both. In some examples, the signal including the phase-tracking reference signal is transmitted in an uplink control channel, an uplink data channel, a downlink control channel, a downlink data channel, or any combination thereof. In some examples, the signal including the phase-tracking reference signal is transmitted in a first subband that is different from a second subband configured for data communications between the first wireless communications device and the second wireless communications device. In some examples, the signal is received via one tone per-physical resource block or per-resource block group configured for the first wireless communications device.

In some examples, the transmission property manager 950 may be configured as or otherwise support a means for adjusting, based on the phase-change pattern, the transmission property during subsequent communications between the first wireless communications device and the second wireless communications device, where the transmission property includes a phase, a timing, a frequency, or any combination thereof.

In some examples, the phase-change indication manager 925 may be configured as or otherwise support a means for configuring the content of the message to indicate the phase-change pattern.

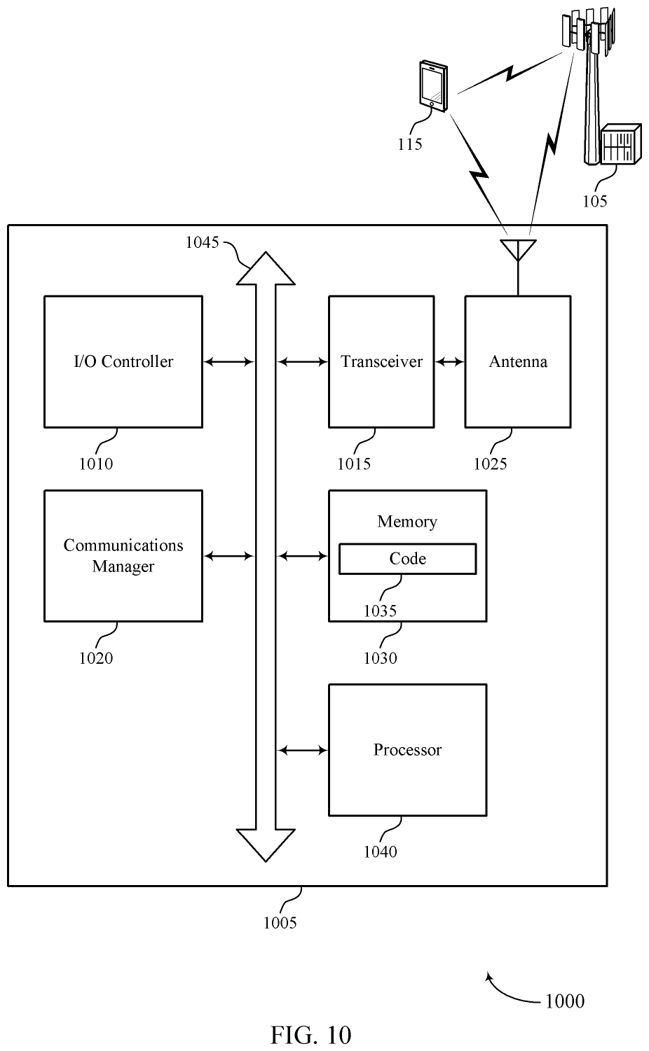

FIG. 10 shows a diagram of a system 1000 including a device 1005 that supports RIS co-existence in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting RIS co-existence). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first wireless communications device in accordance with examples as disclosed herein. For example, the communications manager 1020 may be configured as or otherwise support a means for receiving, from a second wireless communications device, a signal that is indicative of a phase-change pattern applied to communications between the first wireless communications device and the second wireless communications device by a RIS reflecting the communications. The communications manager 1020 may be configured as or otherwise support a means for determining the phase-change pattern from the signal. The communications manager 1020 may be configured as or otherwise support a means for transmitting a message to the second wireless communications device, where at least one of a content or a transmission property of the message is based on the phase-change pattern.

Additionally, or alternatively, the communications manager 1020 may support wireless communication at a first wireless communications device in accordance with examples as disclosed herein. For example, the communications manager 1020 may be configured as or otherwise support a means for determining a phase-change pattern applied to communications between the first wireless communications device and a second wireless communications device by a RIS reflecting the communications. The communications manager 1020 may be configured as or otherwise support a means for transmitting a message to the second wireless communications device indicative of the phase-change pattern, where at least one of a content or a transmission property is based on the phase-change pattern.

By including or configuring the communications manager 1020 in accordance with examples as described herein, the device 1005 may support techniques for improving wireless communications between devices operating in the vicinity of a RIS. The devices may exchange signal(s) and/or message(s) to detect the presence of a RIS and/or quantify the watermarking operations (e.g., phase-change pattern) of the RIS.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of RIS co-existence as described herein, or the processor 1040 and the memory 1030 may be otherwise configured to perform or support such operations.

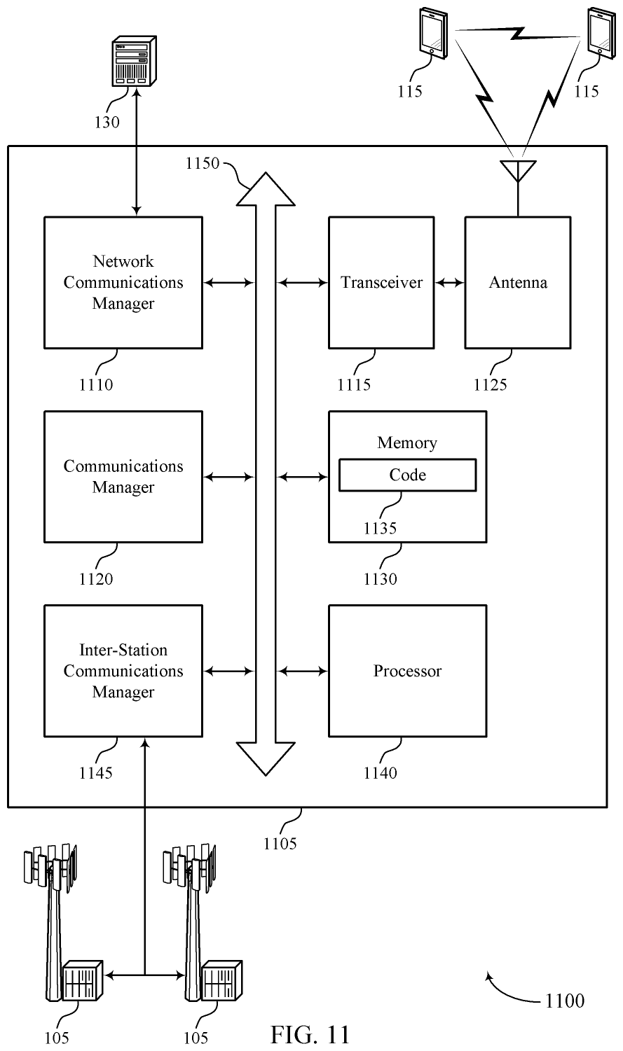

FIG. 11 shows a diagram of a system 1100 including a device 1105 that supports RIS co-existence in accordance with one or more aspects of the present disclosure. The device 1105 may be an example of or include the components of a device 705, a device 805, or a network entity 105 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 715, a transmitter 815, a receiver 710, a receiver 810, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting RIS co-existence). For example, the device 1105 or a component of the device 1105 may include a processor 1140 and memory 1130 coupled with or to the processor 1140, the processor 1140 and memory 1130 configured to perform various functions described herein.

The inter-station communications manager 1145 may manage communications with other network entities 105, and may include a controller or scheduler for controlling communications with UEs 115 in cooperation with other network entities 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between network entities 105.

The communications manager 1120 may support wireless communication at a first wireless communications device in accordance with examples as disclosed herein. For example, the communications manager 1120 may be configured as or otherwise support a means for receiving, from a second wireless communications device, a signal that is indicative of a phase-change pattern applied to communications between the first wireless communications device and the second wireless communications device by a RIS reflecting the communications. The communications manager 1120 may be configured as or otherwise support a means for determining the phase-change pattern from the signal. The communications manager 1120 may be configured as or otherwise support a means for transmitting a message to the second wireless communications device, where at least one of a content or a transmission property of the message is based on the phase-change pattern.

Additionally, or alternatively, the communications manager 1120 may support wireless communication at a first wireless communications device in accordance with examples as disclosed herein. For example, the communications manager 1120 may be configured as or otherwise support a means for determining a phase-change pattern applied to communications between the first wireless communications device and a second wireless communications device by a RIS reflecting the communications. The communications manager 1120 may be configured as or otherwise support a means for transmitting a message to the second wireless communications device indicative of the phase-change pattern, where at least one of a content or a transmission property is based on the phase-change pattern.

By including or configuring the communications manager 1120 in accordance with examples as described herein, the device 1105 may support techniques for improving wireless communications between devices operating in the vicinity of a RIS. The devices may exchange signal(s) and/or message(s) to detect the presence of a RIS and/or quantify the watermarking operations (e.g., phase-change pattern) of the RIS.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of RIS co-existence as described herein, or the processor 1140 and the memory 1130 may be otherwise configured to perform or support such operations.

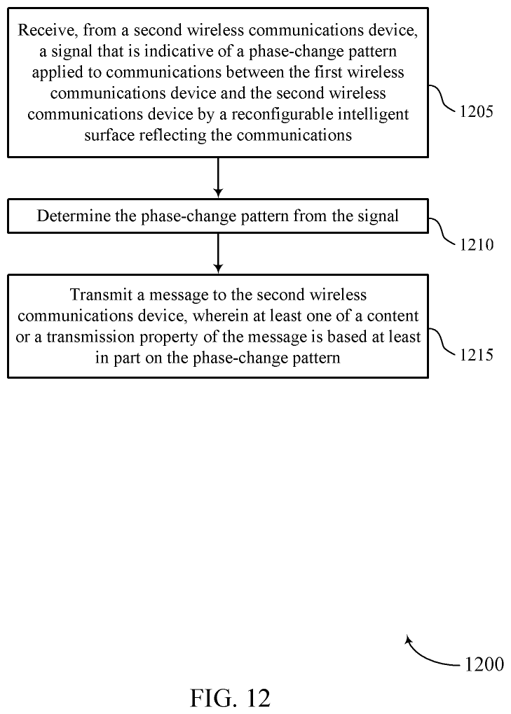

FIG. 12 shows a flowchart illustrating a method 1200 that supports RIS co-existence in accordance with one or more aspects of the present disclosure. The operations of the method 1200 may be implemented by a UE or a network entity (e.g., a base station or its components) as described herein. For example, the operations of the method 1200 may be performed by a UE 115 or a network entity 105 as described with reference to FIGS. 1 through 11. In some examples, a UE or a network entity station may execute a set of instructions to control the functional elements of the UE or the network entity to perform the described functions. Additionally, or alternatively, the UE or the network entity may perform aspects of the described functions using special-purpose hardware.

At 1205, the method may include receiving, from a second wireless communications device, a signal that is indicative of a phase-change pattern applied to communications between the first wireless communications device and the second wireless communications device by a RIS reflecting the communications. The operations of 1205 may be performed in accordance with examples as disclosed herein. In some examples, aspects of the operations of 1205 may be performed by a phase-change indication manager 925 as described with reference to FIG. 9.

At 1210, the method may include determining the phase-change pattern from the signal. The operations of 1210 may be performed in accordance with examples as disclosed herein. In some examples, aspects of the operations of 1210 may be performed by a phase-change determination manager 930 as described with reference to FIG. 9.

At 1215, the method may include transmitting a message to the second wireless communications device, where at least one of a content or a transmission property of the message is based on the phase-change pattern. The operations of 1215 may be performed in accordance with examples as disclosed herein. In some examples, aspects of the operations of 1215 may be performed by a phase-change manager 935 as described with reference to FIG. 9.

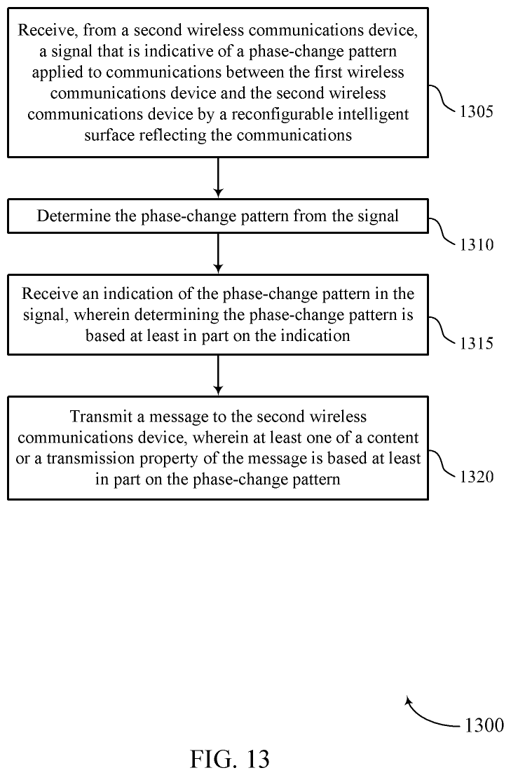

FIG. 13 shows a flowchart illustrating a method 1300 that supports RIS co-existence in accordance with one or more aspects of the present disclosure. The operations of the method 1300 may be implemented by a UE or a network entity (e.g., a base station or its components) as described herein. For example, the operations of the method 1300 may be performed by a UE 115 or a network entity 105 as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include receiving, from a second wireless communications device, a signal that is indicative of a phase-change pattern applied to communications between the first wireless communications device and the second wireless communications device by a RIS reflecting the communications. The operations of 1305 may be performed in accordance with examples as disclosed herein. In some examples, aspects of the operations of 1305 may be performed by a phase-change indication manager 925 as described with reference to FIG. 9.

At 1310, the method may include determining the phase-change pattern from the signal. The operations of 1310 may be performed in accordance with examples as disclosed herein. In some examples, aspects of the operations of 1310 may be performed by a phase-change determination manager 930 as described with reference to FIG. 9.

At 1315, the method may include receiving an indication of the phase-change pattern in the signal, where determining the phase-change pattern is based on the indication. The operations of 1315 may be performed in accordance with examples as disclosed herein. In some examples, aspects of the operations of 1315 may be performed by a coordinated phase-change-manager 940 as described with reference to FIG. 9.

At 1320, the method may include transmitting a message to the second wireless communications device, where at least one of a content or a transmission property of the message is based on the phase-change pattern. The operations of 1320 may be performed in accordance with examples as disclosed herein. In some examples, aspects of the operations of 1320 may be performed by a phase-change manager 935 as described with reference to FIG. 9.

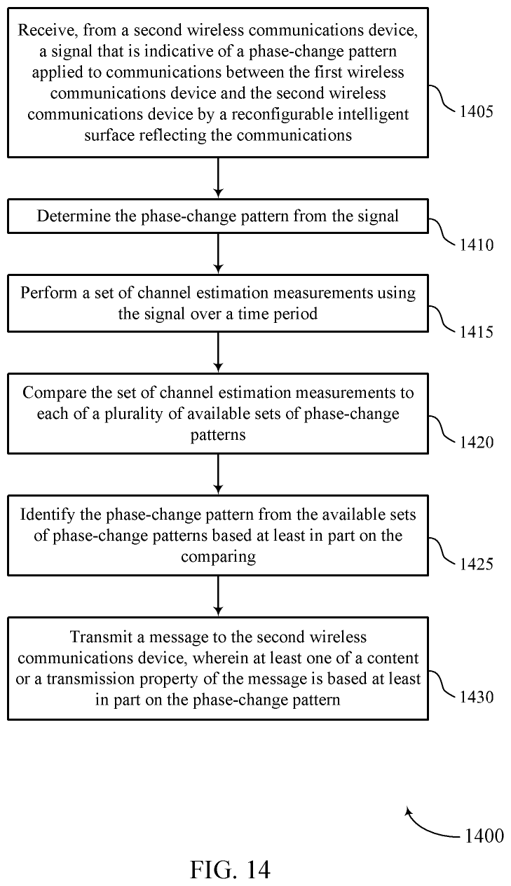

FIG. 14 shows a flowchart illustrating a method 1400 that supports RIS co-existence in accordance with one or more aspects of the present disclosure. The operations of the method 1400 may be implemented by a UE or a network entity (e.g., a base station or its components) as described herein. For example, the operations of the method 1400 may be performed by a UE 115 or a network entity 105 as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include receiving, from a second wireless communications device, a signal that is indicative of a phase-change pattern applied to communications between the first wireless communications device and the second wireless communications device by a RIS reflecting the communications. The operations of 1405 may be performed in accordance with examples as disclosed herein. In some examples, aspects of the operations of 1405 may be performed by a phase-change indication manager 925 as described with reference to FIG. 9.

At 1410, the method may include determining the phase-change pattern from the signal. The operations of 1410 may be performed in accordance with examples as disclosed herein. In some examples, aspects of the operations of 1410 may be performed by a phase-change determination manager 930 as described with reference to FIG. 9.

At 1415, the method may include performing a set of channel estimation measurements using the signal over a time period. The operations of 1415 may be performed in accordance with examples as disclosed herein. In some examples, aspects of the operations of 1415 may be performed by an RS phase-change manager 945 as described with reference to FIG. 9.

At 1420, the method may include comparing the set of channel estimation measurements to each of a set of multiple available sets of phase-change patterns. The operations of 1420 may be performed in accordance with examples as disclosed herein. In some examples, aspects of the operations of 1420 may be performed by an RS phase-change manager 945 as described with reference to FIG. 9.

At 1425, the method may include identifying the phase-change pattern from the available sets of phase-change patterns based on the comparing. The operations of 1425 may be performed in accordance with examples as disclosed herein. In some examples, aspects of the operations of 1425 may be performed by an RS phase-change manager 945 as described with reference to FIG. 9.

At 1430, the method may include transmitting a message to the second wireless communications device, where at least one of a content or a transmission property of the message is based on the phase-change pattern. The operations of 1430 may be performed in accordance with examples as disclosed herein. In some examples, aspects of the operations of 1430 may be performed by a phase-change manager 935 as described with reference to FIG. 9.

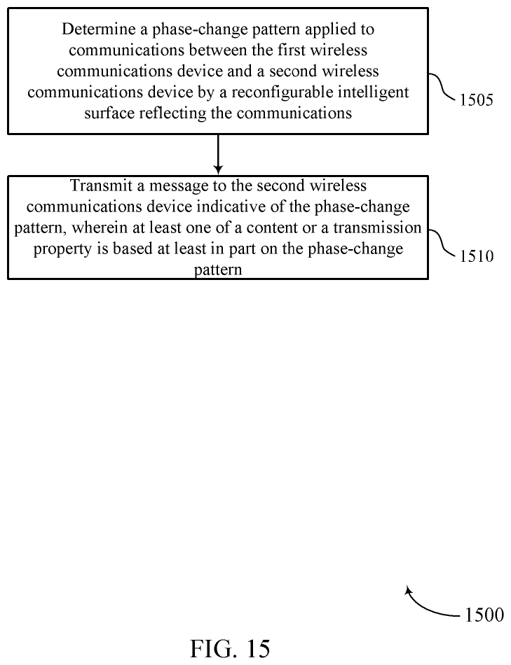

FIG. 15 shows a flowchart illustrating a method 1500 that supports RIS co-existence in accordance with one or more aspects of the present disclosure. The operations of the method 1500 may be implemented by a UE or a network entity (e.g., a base station or its components) as described herein. For example, the operations of the method 1500 may be performed by a UE 115 or a network entity 105 as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include determining a phase-change pattern applied to communications between the first wireless communications device and a second wireless communications device by a RIS reflecting the communications. The operations of 1505 may be performed in accordance with examples as disclosed herein. In some examples, aspects of the operations of 1505 may be performed by a phase-change determination manager 930 as described with reference to FIG. 9.

At 1510, the method may include transmitting a message to the second wireless communications device indicative of the phase-change pattern, where at least one of a content or a transmission property is based on the phase-change pattern. The operations of 1510 may be performed in accordance with examples as disclosed herein. In some examples, aspects of the operations of 1510 may be performed by a phase-change indication manager 925 as described with reference to FIG. 9.

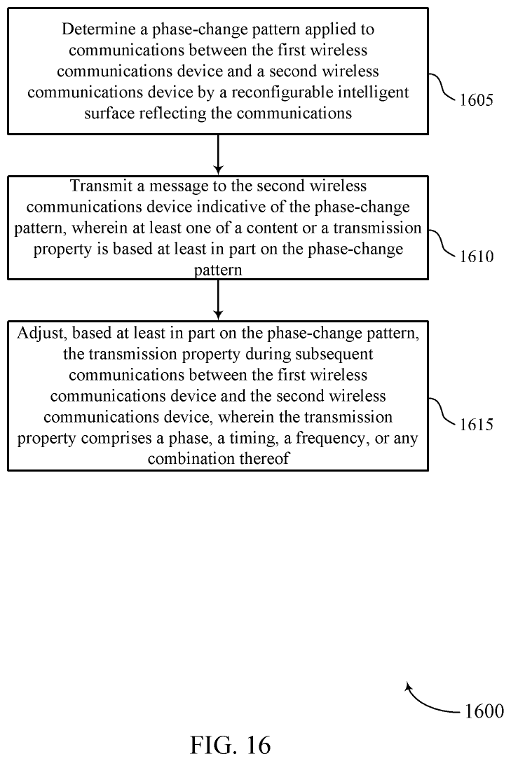

FIG. 16 shows a flowchart illustrating a method 1600 that supports RIS co-existence in accordance with one or more aspects of the present disclosure. The operations of the method 1600 may be implemented by a UE or a network entity (e.g., a base station or its components) as described herein. For example, the operations of the method 1600 may be performed by a UE 115 or a network entity 105 as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include determining a phase-change pattern applied to communications between the first wireless communications device and a second wireless communications device by a RIS reflecting the communications. The operations of 1605 may be performed in accordance with examples as disclosed herein. In some examples, aspects of the operations of 1605 may be performed by a phase-change determination manager 930 as described with reference to FIG. 9.

At 1610, the method may include transmitting a message to the second wireless communications device indicative of the phase-change pattern, where at least one of a content or a transmission property is based on the phase-change pattern. The operations of 1610 may be performed in accordance with examples as disclosed herein. In some examples, aspects of the operations of 1610 may be performed by a phase-change indication manager 925 as described with reference to FIG. 9.

At 1615, the method may include adjusting, based on the phase-change pattern, the transmission property during subsequent communications between the first wireless communications device and the second wireless communications device, where the transmission property includes a phase, a timing, a frequency, or any combination thereof. The operations of 1615 may be performed in accordance with examples as disclosed herein. In some examples, aspects of the operations of 1615 may be performed by a transmission property manager 950 as described with reference to FIG. 9.

The following provides an overview of aspects of the present disclosure:

Aspect 1: A method for wireless communication at a first wireless communications device, the method comprising: receiving, from a second wireless communications device, a signal that is indicative of a phase-change pattern applied to communications between the first wireless communications device and the second wireless communications device by a RIS reflecting the communications: determining the phase-change pattern from the signal; and transmitting a message to the second wireless communications device, wherein at least one of a content or a transmission property of the message is based at least in part on the phase-change pattern.

Aspect 2: The method of aspect 1, wherein determining the phase-change pattern comprises: receiving an indication of the phase-change pattern in the signal, wherein determining the phase-change pattern is based at least in part on the indication.

Aspect 3: The method of aspect 2, wherein the indication of the phase-change pattern comprises a symbol or slot pattern for the phase-change pattern, a watermarking pattern for the RIS, or both.

Aspect 4: The method of any of aspects 1 through 3, wherein determining the phase-change pattern comprises: performing a set of channel estimation measurements using the signal over a time period: comparing the set of channel estimation measurements to each of a plurality of available sets of phase-change patterns; and identifying the phase-change pattern from the available sets of phase-change patterns based at least in part on the comparing.

Aspect 5: The method of aspect 4, further comprising: receiving, from the second wireless communications device, a configuration signal identifying the available sets of phase-change patterns, wherein the configuration signal comprises a downlink control information, a medium access control-control element, a radio resource control, or any combination thereof.

Aspect 6: The method of any of aspects 4 through 5, wherein each phase-change pattern in the available sets of phase-change patterns is associated with a symbol or slot pattern for the phase-change pattern, a watermarking pattern for the RIS, or a combination thereof.

Aspect 7: The method of any of aspects 4 through 6, wherein the signal comprises a reference signal used for RIS detection and tracking, a phase-tracking reference signal, or both.

Aspect 8: The method of aspect 7, wherein the signal comprising the phase-tracking reference signal is received in an uplink control channel, a downlink control channel, or both.

Aspect 9: The method of any of aspects 7 through 8, wherein the signal comprising the phase-tracking reference signal is received in a first subband that is different from a second subband configured for data communications between the first wireless communications device and the second wireless communications device.

Aspect 10: The method of any of aspects 7 through 9, wherein the signal is received via one tone per-physical resource block or per-resource block group configured for the first wireless communications device.

Aspect 11: The method of any of aspects 4 through 10, wherein performing the set of channel estimation measurements using the signal over the time period comprises: identifying a periodicity for the phase-change pattern; and performing a set of channel estimation measurements using a plurality of signals, each received during different periodic instances of the phase-change pattern in accordance with the periodicity.

Aspect 12: The method of any of aspects 1 through 11, further comprising: adjusting, based at least in part on the phase-change pattern, the transmission property during subsequent communications between the first wireless communications device and the second wireless communications device, wherein the transmission property comprises a phase, a timing, a frequency, or any combination thereof.

Aspect 13: The method of any of aspects 1 through 12, further comprising: configuring the content of the message to indicate the phase-change pattern.

Aspect 14: A method for wireless communication at a first wireless communications device, the method comprising: determining a phase-change pattern applied to communications between the first wireless communications device and a second wireless communications device by a RIS reflecting the communications; and transmitting a message to the second wireless communications device indicative of the phase-change pattern, wherein at least one of a content or a transmission property is based at least in part on the phase-change pattern.

Aspect 15: The method of aspect 14, wherein determining the phase-change pattern comprises: receiving, from a third wireless communications device, an indication of the phase-change pattern, wherein the message transmitted to the second wireless communications device includes the indication of the phase-change pattern.

Aspect 16: The method of aspect 15, wherein the indication of the phase-change pattern comprises a symbol or slot pattern for the phase-change pattern, a watermarking pattern for the RIS, or both.

Aspect 17: The method of any of aspects 15 through 16, wherein the third wireless communications device comprises a network entity associated with the RIS, a UE associated with the first wireless communications device, or both.

Aspect 18: The method of any of aspects 14 through 17, wherein determining the phase-change pattern comprises: transmitting, to the second wireless communications device, a signal to which the phase-change pattern is applied by the RIS; and receiving an indication of the phase-change pattern from the second wireless communications device, wherein the indication is based at least in part on measurements of the signal.

Aspect 19: The method of aspect 18, further comprising: transmitting, to the second wireless communications device, a configuration signal identifying available sets of phase-change patterns, wherein the configuration signal comprises a downlink control information, a medium access control-control element, a radio resource control, or any combination thereof.

Aspect 20: The method of aspect 19, wherein each phase-change pattern in the available sets of phase-change patterns is associated with a symbol or slot pattern for the phase-change pattern, a watermarking pattern for the RIS, or a combination thereof.

Aspect 21: The method of any of aspects 18 through 20, wherein the signal comprises a reference signal used for RIS detection and tracking, a phase-tracking reference signal, or both.

Aspect 22: The method of aspect 21, wherein the signal comprising the phase-tracking reference signal is transmitted in an uplink control channel, an uplink data channel, a downlink control channel, a downlink data channel, or any combination thereof.

Aspect 23: The method of any of aspects 21 through 22, wherein the signal comprising the phase-tracking reference signal is transmitted in a first subband that is different from a second subband configured for data communications between the first wireless communications device and the second wireless communications device.

Aspect 24: The method of any of aspects 21 through 23, wherein the signal is received via one tone per-physical resource block or per-resource block group configured for the first wireless communications device.

Aspect 25: The method of any of aspects 14 through 24, further comprising: adjusting, based at least in part on the phase-change pattern, the transmission property during subsequent communications between the first wireless communications device and the second wireless communications device, wherein the transmission property comprises a phase, a timing, a frequency, or any combination thereof.

Aspect 26: The method of any of aspects 14 through 25, further comprising: configuring the content of the message to indicate the phase-change pattern.

Aspect 27: An apparatus for wireless communication at a first wireless communications device, comprising a processor: memory coupled with the processor; and instructions stored in the memory and executable by the processor to cause the apparatus to perform a method of any of aspects 1 through 13.

Aspect 28: An apparatus for wireless communication at a first wireless communications device, comprising at least one means for performing a method of any of aspects 1 through 13.

Aspect 29: A non-transitory computer-readable medium storing code for wireless communication at a first wireless communications device, the code comprising instructions executable by a processor to perform a method of any of aspects 1 through 13.

Aspect 30: An apparatus for wireless communication at a first wireless communications device, comprising a processor: memory coupled with the processor; and instructions stored in the memory and executable by the processor to cause the apparatus to perform a method of any of aspects 14 through 26.

Aspect 31: An apparatus for wireless communication at a first wireless communications device, comprising at least one means for performing a method of any of aspects 14 through 26.

Aspect 32: A non-transitory computer-readable medium storing code for wireless communication at a first wireless communications device, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first wireless communications device, the method comprising:
receiving, from a second wireless communications device, a signal that is indicative of a phase-change pattern applied to communications between the first wireless communications device and the second wireless communications device by a reconfigurable intelligent surface reflecting the communications;
determining the phase-change pattern from the signal; and
transmitting a message to the second wireless communications device, wherein at least one of a content or a transmission property of the message is based at least in part on the phase-change pattern.

2. The method of claim 1, wherein determining the phase-change pattern comprises:
receiving an indication of the phase-change pattern in the signal, wherein determining the phase-change pattern is based at least in part on the indication.

3. The method of claim 2, wherein the indication of the phase-change pattern comprises a symbol or slot pattern for the phase-change pattern, a watermarking pattern for the reconfigurable intelligent surface, or both.

4. The method of claim 1, wherein determining the phase-change pattern comprises:
performing a set of channel estimation measurements using the signal over a time period;
comparing the set of channel estimation measurements to each of a plurality of available sets of phase-change patterns; and
identifying the phase-change pattern from the available sets of phase-change patterns based at least in part on the comparing.

5. The method of claim 4, further comprising:
receiving, from the second wireless communications device, a configuration signal identifying the available sets of phase-change patterns, wherein the configuration signal comprises a downlink control information, a medium access control-control element, a radio resource control, or any combination thereof.

6. The method of claim 4, wherein each phase-change pattern in the available sets of phase-change patterns is associated with a symbol or slot pattern for the phase-change pattern, a watermarking pattern for the reconfigurable intelligent surface, or a combination thereof.

7. The method of claim 4, wherein the signal comprises a reference signal used for reconfigurable intelligent surface detection and tracking, a phase-tracking reference signal, or both.

8. The method of claim 7, wherein the signal comprising the phase-tracking reference signal is received in an uplink control channel, a downlink control channel, or both.

9. The method of claim 7, wherein the signal comprising the phase-tracking reference signal is received in a first subband that is different from a second subband configured for data communications between the first wireless communications device and the second wireless communications device.

10. The method of claim 7, wherein the signal is received via one tone per-physical resource block or per-resource block group configured for the first wireless communications device.

11. The method of claim 4, wherein performing the set of channel estimation measurements using the signal over the time period comprises:
identifying a periodicity for the phase-change pattern; and
performing a set of channel estimation measurements using a plurality of signals, each received during different periodic instances of the phase-change pattern in accordance with the periodicity.

12. The method of claim 1, further comprising:
adjusting, based at least in part on the phase-change pattern, the transmission property during subsequent communications between the first wireless communications device and the second wireless communications device, wherein the transmission property comprises a phase, a timing, a frequency, or any combination thereof.

13. The method of claim 1, further comprising:
configuring the content of the message to indicate the phase-change pattern.

14. A method for wireless communication at a first wireless communications device, the method comprising:
determining a phase-change pattern applied to communications between the first wireless communications device and a second wireless communications device by a reconfigurable intelligent surface reflecting the communications; and
transmitting a message to the second wireless communications device indicative of the phase-change pattern, wherein at least one of a content or a transmission property is based at least in part on the phase-change pattern.

15. The method of claim 14, wherein determining the phase-change pattern comprises:
receiving, from a third wireless communications device, an indication of the phase-change pattern, wherein the message transmitted to the second wireless communications device includes the indication of the phase-change pattern.

16. The method of claim 15, wherein the indication of the phase-change pattern comprises a symbol or slot pattern for the phase-change pattern, a watermarking pattern for the reconfigurable intelligent surface, or both.

17. The method of claim 15, wherein the third wireless communications device comprises a network entity associated with the reconfigurable intelligent surface, a user equipment (UE) associated with the first wireless communications device, or both.

18. The method of claim 14, wherein determining the phase-change pattern comprises:
transmitting, to the second wireless communications device, a signal to which the phase-change pattern is applied by the reconfigurable intelligent surface; and
receiving an indication of the phase-change pattern from the second wireless communications device, wherein the indication is based at least in part on measurements of the signal.

19. The method of claim 18, further comprising:
transmitting, to the second wireless communications device, a configuration signal identifying available sets of phase-change patterns, wherein the configuration signal comprises a downlink control information, a medium access control-control element, a radio resource control, or any combination thereof.

20. The method of claim 19, wherein each phase-change pattern in the available sets of phase-change patterns is associated with a symbol or slot pattern for the phase-change pattern, a watermarking pattern for the reconfigurable intelligent surface, or a combination thereof.

21. The method of claim 18, wherein the signal comprises a reference signal used for reconfigurable intelligent surface detection and tracking, a phase-tracking reference signal, or both.

22. The method of claim 21, wherein the signal comprising the phase-tracking reference signal is transmitted in an uplink control channel, an uplink data channel, a downlink control channel, a downlink data channel, or any combination thereof.

23. The method of claim 21, wherein the signal comprising the phase-tracking reference signal is transmitted in a first subband that is different from a second subband configured for data communications between the first wireless communications device and the second wireless communications device.

24. The method of claim 21, wherein the signal is received via one tone per-physical resource block or per-resource block group configured for the first wireless communications device.

25. The method of claim 14, further comprising:
adjusting, based at least in part on the phase-change pattern, the transmission property during subsequent communications between the first wireless communications device and the second wireless communications device, wherein the transmission property comprises a phase, a timing, a frequency, or any combination thereof.

26. The method of claim 14, further comprising:
configuring the content of the message to indicate the phase-change pattern.

27. An apparatus for wireless communication at a first wireless communications device, comprising:
a processor; and
memory coupled with the processor, the memory comprises instructions executable by the processor to cause the apparatus to:
receive, from a second wireless communications device, a signal that is indicative of a phase-change pattern applied to communications between the first wireless communications device and the second wireless communications device by a reconfigurable intelligent surface reflecting the communications;
determine the phase-change pattern from the signal; and
transmit a message to the second wireless communications device, wherein at least one of a content or a transmission property of the message is based at least in part on the phase-change pattern.

28. The apparatus of claim 27, wherein the instructions to determine the phase-change pattern are executable by the processor to cause the apparatus to:
receive an indication of the phase-change pattern in the signal, wherein determining the phase-change pattern is based at least in part on the indication.

29. An apparatus for wireless communication at a first wireless communications device, comprising:
a processor; and
memory coupled with the processor, the memory comprises instructions executable by the processor to cause the apparatus to:
determine a phase-change pattern applied to communications between the first wireless communications device and a second wireless communications device by a reconfigurable intelligent surface reflecting the communications; and
transmit a message to the second wireless communications device indicative of the phase-change pattern, wherein at least one of a content or a transmission property is based at least in part on the phase-change pattern.

30. The apparatus of claim 29, wherein the instructions to determine the phase-change pattern are executable by the processor to cause the apparatus to:
receive, from a third wireless communications device, an indication of the phase-change pattern, wherein the message transmitted to the second wireless communications device includes the indication of the phase-change pattern.
